(19) United States
(12) Patent Application Publication
(10) Pub. No.: US 2024/0056504 A1
(43) Pub. Date: Feb. 15, 2024

(54) ACCESSING HARDWARE RESOURCES IN DISTRIBUTED COMPUTING ENVIRONMENTS

(71) Applicant: InterDigital Patent Holdings, Inc., Wilmington, DE (US)

(72) Inventors: Renan Krishna, Brighton (GB); Ulises Olvera-Hernandez, Saint-Lazare (CA); Magurawalage Chathura Madhusanka Sarathchandra, London (GB)

(73) Assignee: InterDigital Patent Holdings, Inc., Wilmington, DE (US)

(21) Appl. No.: 18/271,391

(22) PCT Filed: Jan. 7, 2022
(86) PCT No.: PCT/US2022/011549

§ 371 Date: Jul. 7, 2023

Related U.S. Application Data
(60) Provisional application No. 63/134,801, filed on Jan. 7, 2021.

(51) Int. Cl. H04L 67/141

(52) U.S. Cl. CPC H04L 67/141

(57) ABSTRACT

Systems, methods, and apparatuses are described herein for accessing hardware resources in distributed computing environments, Remote hardware (e.g., hardware resources) may be accessed, for example, using interfaces (e.g., device driver interfaces). Remote hardware (e.g., within a terminal and/or on the edge) may be accessed, for example, to enable computationally intensive applications (e.g., multi-player games, augmented/virtual reality) to be run on terminal devices, A wireless transmit/receive unit (WTRU) may enable emote hardware access.

### CROSS-REFERENCE TO RELATED APPLICATIONS

The application claims the benefit of U.S. Provisional Application 63/134,801, filed Jan. 7, 2021, the contents of which are incorporated by reference in their entirety herein.

### BACKGROUND

Current terminal device architectures may have shortcomings that need to be addressed including, for example, a lack of ability to make hardware (HW) resources available for the execution of computationally intensive applications. Current techniques/mechanisms for accessing hardware resources on a terminal device may include Instruction Set Architectures (ISA), Application Binary Interfaces (ABI), Application Programming Interfaces (API), etc. These techniques/mechanism may not support current access to remote HW resources and HW resources on the terminal device.

### SUMMARY

Systems, methods, and apparatuses are described herein for accessing hardware resources in distributed computing environments. Remote hardware (e.g., hardware resources) may be accessed, for example, using interfaces (e.g., device driver interfaces). Remote hardware (e.g., within a terminal and/or on the edge) may be accessed, for example, to enable computationally intensive applications (e.g., multi-player games, augmented/virtual reality) to be run on terminal devices. A wireless transmit/receive unit (WTRU) may enable remote hardware access.

For example, a WTRU may comprise a memory and/or a processor. The WTRU may be configured to receive a first message from a network. The first message may indicate a list of hardware resource identifiers for one or more hardware resources (e.g., to be remotely accessed). The one or more hardware resources may be associated with a location of the WTRU. The one or more hardware resources may be associated with a hardware criteria for an application executing on the WTRU. The WTRU may be configured to send a second message to the network. The second message may indicate a request to establish a data session (e.g., protocol data unit (PDU) session). The second message may indicate a resource identifier for a hardware resource selected from the list of the hardware resource identifiers. The WTRU may be configured to receive a third message from the network. The third message may indicate configuration information (e.g., provisioning information) to access the selected hardware resource. The configuration information may be associated with a first server (e.g., an edge enabler server) that provides the hardware resource. The third message may be received in response to the request to establish the data session.

In examples, the WTRU may be configured to send a fourth message. The fourth message may be sent using the data session. The fourth message may comprise data for the selected hardware resource.

In examples, the WTRU may be configured to receive a fifth message. The fifth message may indicate a second server (e.g., edge configuration server). The second server may be associated with the resource identifier indicated in the second message. The second server may provide the configuration information (e.g., provisioning information), for example, associated with the first server providing the hardware resource(s). The configuration information may indicate at least one of the following: a configuration identification, a reference to an access token and an associated broker object, a handle to access a time stamp counter, a flags register (e.g., an enhanced flags (EFLAGS) register), a translation look aside buffer, or an access to calls (e.g., via handles for fault and abort operations).

In examples, the request sent to the network may indicate a user intent. The user intent may be mapped to the selected hardware resource.

In examples, the WTRU may be configured to send initialization information (e.g., to the network). The initialization information may indicate one or more of the following: a location of the WTRU, a WTRU identification, and/or the hardware criteria for the application executing on the WTRU. The location of the WTRU may be associated with one or more of the following: a geographical coordinate, a network location, a distance from the WTRU, a distance within a network, and/or a number of hops. The hardware criteria may be associated with at least one of the following: a quality of service associated with the application, a quality of service associated with the data session, a user intent associated with the application, a performance requirement for the hardware resource, a memory requirement for the hardware resource, and/or a context associated with the application.

In examples, the hardware resource identifier may be selected, for example, based on a context associated with the application. The context may be a system-based context, a game-based context, and/or the like. A system-based context may be associated with one or more of the following: a number of hopes between the WTRU and the first server, a wireless condition, a processor/memory utilization associated with the WTRU, etc. A game-based context may be associated with one or more of the following: a number of players in a game, an image to display, a color of a background, a scenery, a number of objects available to a player, a viewing direction (e.g., direction a player is facing), a time of day, a location, an audience rating (e.g., over 18, PR), etc.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodimen.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a diagram illustrating an example architecture of a computer system such as a wireless transmit receive unit (WTRU).

FIG. 3 is a diagram illustrating example interactions between a client and a server.

FIG. 4 is a diagram illustrating an example architecture that may provide support for edge applications.

FIG. 5 is a diagram illustrating an example of service provisioning.

FIG. 6 is a diagram illustrating example trap operations.

FIG. 7 is a diagram illustrating an example of a filesystem abstraction that may be used to access HW devices or resources.

FIG. 8 is a diagram illustrating example client-server interaction in the cloud.

FIG. 9 is a diagram illustrating an example of app development on a terminal device such as a WTRU.

FIG. 10 is a diagram illustrating an example of server failure management in the cloud.

FIG. 11 is a diagram illustrating example 5G-XR interfaces and an example 5G-XR architecture.

FIG. 12 is a diagram illustrating an example terminal device architecture.

FIG. 13 is a diagram illustrating an example of a grant permission token.

FIG. 14 is a diagram illustrating example pass-by-reference semantics that may be used by a hardware provisioning module.

FIG. 15 is a diagram illustrating example operations associated with granting and/or withdrawing resource access requests.

FIG. 16 is a diagram illustrating example operations associated with withdrawing a permission token.

FIG. 17 is a diagram illustrating an example of directly accessing HW resources.

FIG. 18 is a diagram illustrating an example of encapsulating device specific calls.

FIG. 19 is a diagram illustrating example message sequences between an app and a hardware device.

FIG. 20 is a diagram illustrating an example workflow associated with accessing HW features from an app.

FIG. 21 is a diagram illustrating example operations associated with granting a session taken for accessing an edge device.

FIG. 22 is a diagram illustrating an example architecture that may support edge computing.

FIG. 23 is a diagram illustrating an example architecture that may support stateless clients and/or servers.

FIG. 24 is a diagram illustrating an example of packaging an app into a unikernel.

FIG. 25 is a diagram illustrating example operations associated with sending data from an app to an edge device.

FIG. 26 is a diagram illustrating example operations associated with sending data from an edge device to an app.

FIG. 27 is a diagram illustrating example semantics associated with interactions between a client and a stateless edge device.

FIG. 28 is a diagram illustrating example semantics associated with client-initiated interactions based on changing availabilities of HW resources.

FIG. 29 is a diagram illustrating an example of discovering edge hosting resources.

FIG. 30 is a diagram illustrating example operations associated with authorization and authentication of edge hosting entities.

FIG. 31 is a diagram illustrating example operations associated with an edge device access component and a location device access component.

FIG. 32 is a diagram illustrating example extensions that may be applied to 5G-XR interfaces and/or architectures.

### EXAMPLE NETWORKS FOR IMPLEMENTATION OF THE EMBODIMENTS

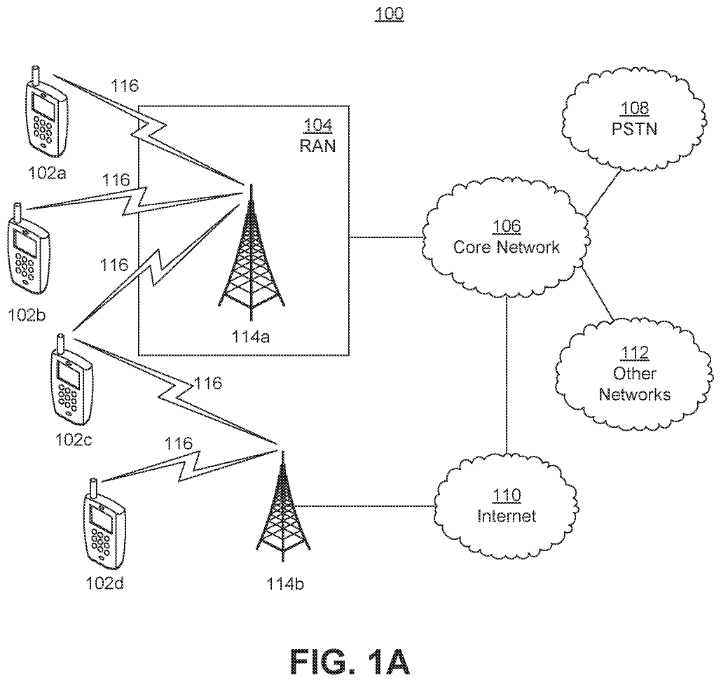

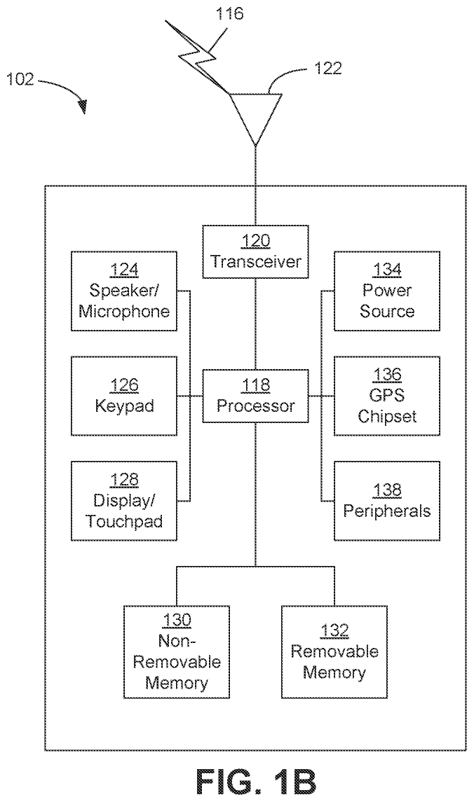

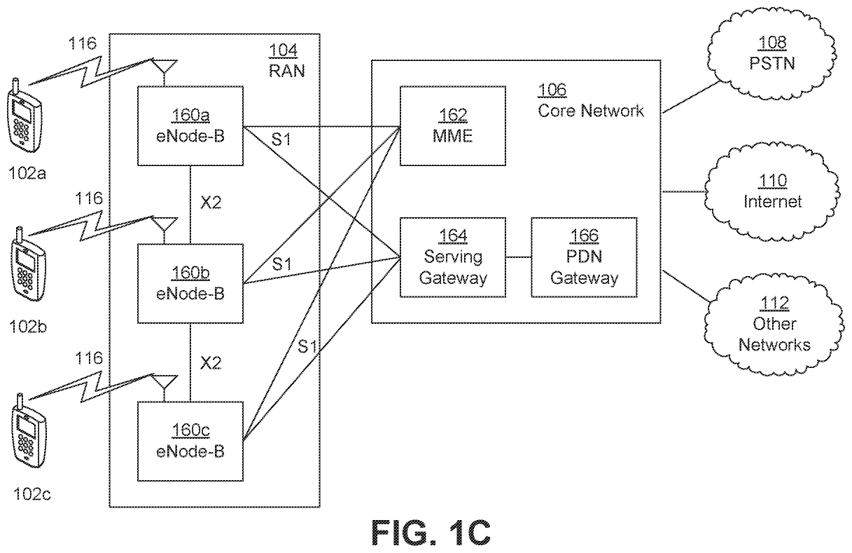

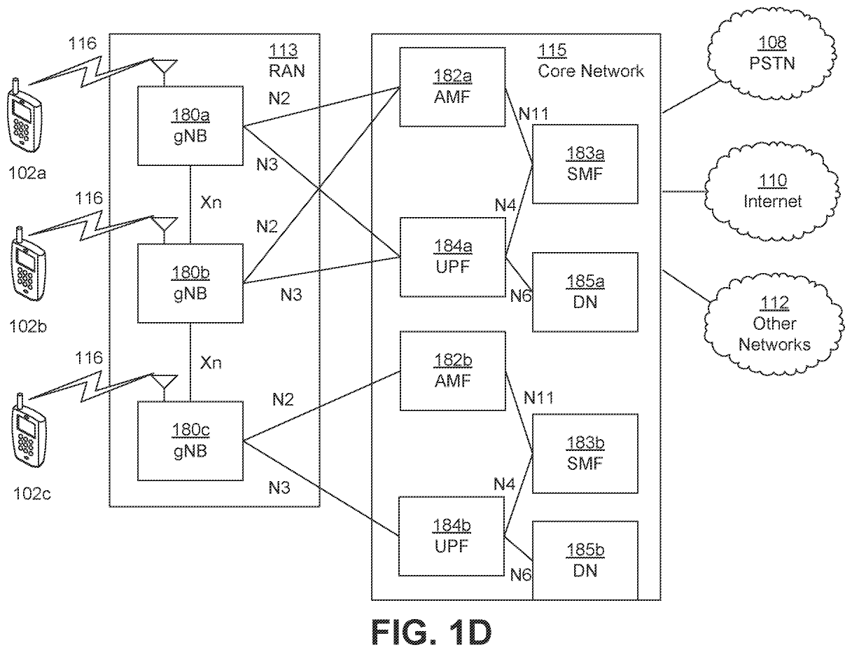

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a ‘station’ and/or a ‘STA’, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c, and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B (eNB), a Home Node B, a Home eNode B, a gNode B (gNB), a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN).

In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, alight sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements is depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an ‘ad-hoc’ mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac, 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like.

Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Systems, methods, and apparatuses are described herein for accessing hardware resources in distributed computing environments. Remote hardware (e.g., hardware resources) may be accessed, for example, using interfaces (e.g., device driver interfaces). Remote hardware (e.g., within a terminal and/or on the edge) may be accessed, for example, to enable computationally intensive applications (e.g., multi-player games, augmented/virtual reality) to be run on terminal devices. A wireless transmit/receive unit (WTRU) may enable remote hardware access.

For example, a WTRU may comprise a memory and/or a processor. The WTRU may be configured to receive a first message from a network. The first message may indicate a list of hardware resource identifiers for one or more hardware resources (e.g., to be remotely accessed). The one or more hardware resources may be associated with a location of the WTRU. The one or more hardware resources may be associated with a hardware criteria for an application executing on the WTRU. The WTRU may be configured to send a second message to the network. The second message may indicate a request to establish a data session (e.g., protocol data unit (PDU) session). The second message may indicate a resource identifier for a hardware resource selected from the list of the hardware resource identifiers. The WTRU may be configured to receive a third message from the network. The third message may indicate configuration information (e.g., provisioning information) to access the selected hardware resource. The configuration information may be associated with a first server (e.g., an edge enabler server) that provides the hardware resource. The third message may be received in response to the request to establish the data session.

In examples, the WTRU may be configured to send a fourth message. The fourth message may be sent using the data session. The fourth message may comprise data for the selected hardware resource.

In examples, the WTRU may be configured to receive a fifth message. The fifth message may indicate a second server (e.g., edge configuration server). The second server may be associated with the resource identifier indicated in the second message. The second server may provide the configuration information (e.g., provisioning information), for example, associated with the first server providing the hardware resource(s). The configuration information may indicate at least one of the following: a configuration identification, a reference to an access token and an associated broker object, a handle to access a time stamp counter, an EDGLAS register, a translation look aside buffer, or an access to calls (e.g., via handles for fault and abort operations).

In examples, the request sent to the network may indicate a user intent. The user intent may be mapped to the selected hardware resource.

In examples, the WTRU may be configured to send initialization information (e.g., to the network). The initialization information may indicate one or more of the following: a location of the WTRU, a WTRU identification, and/or the hardware criteria for the application executing on the WTRU. The location of the WTRU may be associated with one or more of the following: a geographical coordinate, a network location, a distance from the WTRU, a distance within a network, and/or a number of hops. The hardware criteria may be associated with at least one of the following: a quality of service associated with the application, a quality of service associated with the data session, a user intent associated with the application, a performance requirement for the hardware resource, a memory requirement for the hardware resource, and/or a context associated with the application.

In examples, the hardware resource identifier may be selected, for example, based on a context associated with the application. The context may be a system-based context, a game-based context, and/or the like. A system-based context may be associated with one or more of the following: a number of hopes between the WTRU and the first server, a wireless condition, a processor/memory utilization associated with the WTRU, etc. A game-based context may be associated with one or more of the following: a number of players in a game, an image to display, a color of a background, a scenery, a number of objects available to a player, a viewing direction (e.g., direction a player is facing), a time of day, a location, an audience rating (e.g., over 18, PR), etc.

Described herein are systems, methods, and instrumentalities associated with network function decomposition device virtualization. An extended hypervisor may be implemented to act as a token management component, which may allow hardware and/or software modules to execute in their own protected domain through a token (e.g., without system call protection). A local device access component may handle access to local HW resources, e.g., via an access token. An edge device access component may handle access to remote HW resources (e.g., computing resources). An enhanced ABI component (e.g., which may be optional) may be compiled into a unikernel, for example, with (e.g., only) components that may be facilitate the operation of a cloudlet-native app.

One or more the components described herein may offer a combination of low and/or high-level abstractions that may be used by apps running in a user space, for example, through a token that enables access to one or more protected modules (e.g., hardware and/or software modules). HW resources may accessed based on 3GPP procedures and/or resource ID(s). The access may be authorization and/or authenticated at the edge of a network, for example, based on a resource ID (e.g., an application generated resource ID). A user intent vector may be utilized to select one or more edge configuration servers.

One or more of the following mechanisms or techniques may be implemented and/or adopted in a computing device to gain access to hardware and/or storage resources. A computing device, a terminal device, and a computer system may be used interchangeably herein with a WTRU. A module may be used interchangeably herein with a component including a hardware component, a software component or a combination thereof. A mechanism or mechanisms may include techniques, functions, components, processes, methods, and/or operations that may be implemented using hardware and/or software.

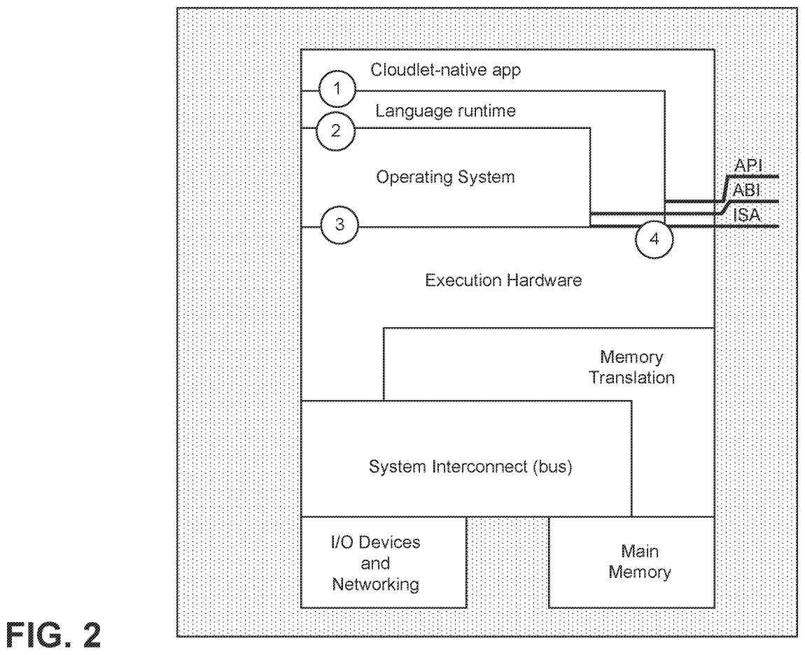

Computer systems may be organized into various abstraction levels and interfaces, for example, as shown in FIG. 2. These may include, for example, an instruction set architecture (ISA), an application binary interface (ABI), and an application programming interface (API) that may be close to or on a hardware/software boundary. Implementation layers (e.g., key implementation layers) may communicate vertically via the ISA, ABI, and/or API.

The ISA may operate as an interface, for example, at a boundary between hardware and software. For example, as shown in FIG. 2, the interfaces (e.g., the interface at 3 and the interface at 4) may represent the ISA. For example, the interface (e.g., the interface at 3) may be referred to as the system ISA. For example, the interface (e.g., the interface at 4) may be referred to as the user ISA.

The system ISA may expose instructions that are visible to the operating system (e.g., only to operating system). Instructions (e.g., instructions visible to the operating system) may be used, for example, to manage system resources. The user ISA may expose instructions that are visible to an application program and/or an operating system. Instructions (e.g., instructions visible to an application program and/or an operating system) may be used, for example, to complete computational tasks (e.g., mainly to complete computational tasks). For examples, the ISA may include the Intel 64 and IA-32.

The ABI may comprise a user ISA (e.g., the interface at 4 in FIG. 2) and/or one or more system call interfaces (e.g., the interface at 2 in FIG. 2). The system call interface(s) may enable an application program to access (e.g., indirectly access) shared resources, for example, by invoking one or more operating system services. For example, a system call interface (e.g., a standard system call interface) may be the POSIX system call standard for UNIX based systems.

The API may comprise a user ISA (e.g., the interface at 4 shown in FIG. 2) and/or one or more high-level language library calls (e.g., which may be implemented via interface 1 shown in FIG. 2). Library calls may be used by an application program, for example, to access the ABI. For example, an API may include the Java API (e.g., for reading and writing to files).

Computing architectures may support access to the hardware functionality of a local machine (e.g., a WTRU). Computing architectures on a terminal device (e.g., a WTRU) may allow apps (e.g., applications) to access limited hardware functionality, for example, through a user ISA. The apps may go through a language runtime layer and/or an operating system layer, for example, to access hardware hidden by the system ISA (e.g., the interface at 3 in FIG. 2). Such a mechanism may result in multiplicative performance penalties for the terminal device and/or render the terminal device unable to run apps, for example, apps that may request a high performance from the device (e.g., AR/VR, gaming, and/or machine-learning (ML) based apps).

An operating system may hide the system ISA, for example, by creating a binary protection mode (e.g., a user mode and/or a kernel mode). In examples, processes that are executing in the kernel mode (e.g., only processes that are executing in the kernel mode) may access the system ISA. A process (e.g., process running in the user mode) may use a system call interface (e.g., provided by the operating system) to send a request, for example, if the process running in the user mode accesses the system ISA. The kernel of the operating system may check if the request is valid. The kernel of the operating system may execute the system call, for example, on behalf of the process running in the user mode. This system call technique may be employed to ensure that the operating system maintain isolation between processes that are running concurrently and accessing system resources (e.g., processors and memory).

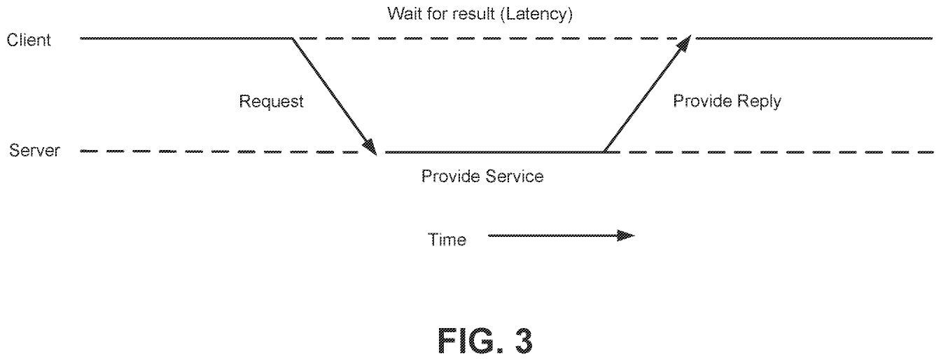

Computing architectures may support access to a remote machine's hardware functionality. A computing architecture may allow distributed apps to be partitioned into a role (e.g., a client role and a server role). A client (e.g., a WTRU and/or a program running on the WTRU) may include processes that assume the responsibility of making a request A server may include processes (e.g., on remote machines) that assume the responsibility of responding to the request, e.g., as shown in FIG. 3.

Client processes may access local hardware resources on a terminal device (e.g., a WTRU). Server processes may access hardware on a remote machine. A terminal architecture may refrain from making (e.g., not make) a distinction between a server machine that is multiple (e.g., many) hops away (e.g., in the cloud) and one that is fewer hops (e.g., one hop) away (e.g., on the edge of a network). These approaches may introduce unpredictable latency in the communication between a client and a server (e.g., as shown in FIG. 3), which may affect them in running computationally intensive and/or time critical apps such as AR/VR, gaming, and ML-based apps that may have low-latency requirements (e.g., render them unsuitable to run the computationally intensive and/or time critical apps).

Terminal architectures may be developed and/or improved. The design of an architecture may depend on the device(s) being targeted. These devices may include, for example, handheld devices (e.g., those running Android and/or iOS), embedded devices (e.g., those running embedded Linux, QNX, VxWorks), and/or devices that run real-time systems (e.g., medical imaging systems, industrial control systems, home appliance controllers, automobile-fuel injection systems, etc.).

Target users of handheld and/or embedded systems may include consumers. The target use of real-time systems may include industrial applications. Handheld systems (e.g., Android and iOS-based systems) may refrain from allowing (e.g., not allow) apps to directly access HW. Embedded devices and/or real-time systems may include single application systems, for example, configured to run on a dedicated device.

The inability of operating system architectures (OS) to allow applications to access (e.g., directly access) HW may result in substantial performance penalties. The performance of persistent stores and/or garbage collectors may suffer, for example, as a result of generic virtual memory primitives offered by these OS architectures. Algorithms that are specific to an application (e.g., rather than ones that are generic to the OS) may improve application performance.

Edge computing may be considered in the design of a computing architecture. System architectures (e.g., such as those used in the fifth generation of cellular networks) may increasingly utilize edge computing techniques, for example, to reduce latency. Traffic identified to be sensitive to latency may be diverted to computing resources closer to the user, e.g., with an aim of reducing the overall round trip time (RTT).

Access to edge computing resources may be made more efficient, e.g., to enable discovery of edge application servers and/or handle mobility across user plane function (UPF) anchors. This may lead to IP reallocation, which may disrupt certain applications.

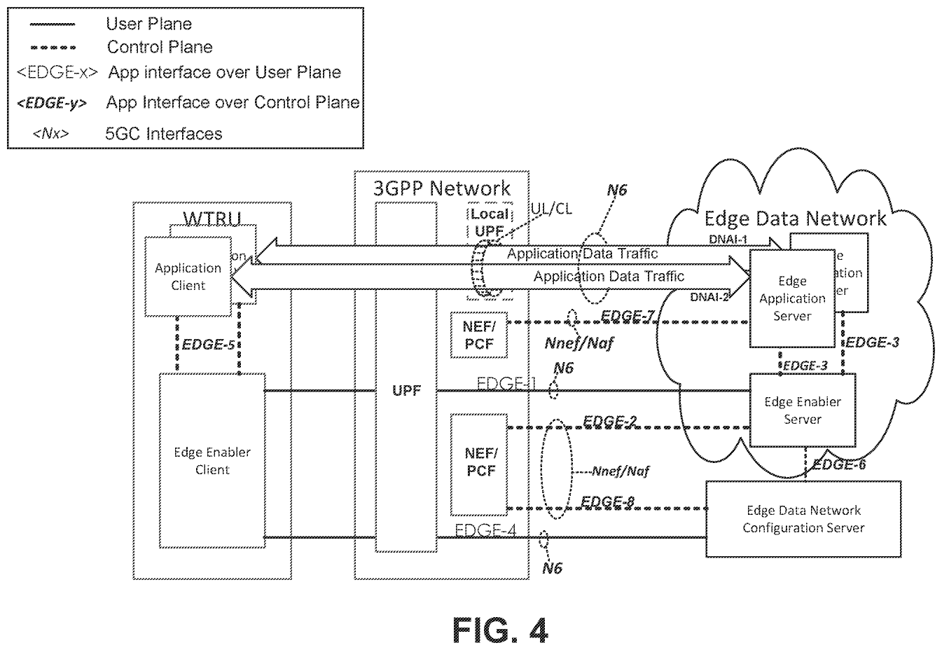

FIG. 4 depicts an example system architecture (e.g., for a 5G system) that illustrates application level and system level interfaces. As shown, the architecture may include architectural network entities such as a local UPF which may be configured to provide an uplink classifier (UL CL) to divert traffic to local servers. Application servers (e.g., different application servers) with distinct functionality and/or characteristics may highlight aspects of application configuration, application context management, and/or application server discovery amongst others. An edge configuration server may provision (e.g., be responsible for provisioning of) edge configuration information in the client, which may enable an edge application client to connect with an appropriate edge application server. A client may be authorized through an authentication and/or an authorization procedure, for example, before an edge application client may access an application server such an edge configuration server.

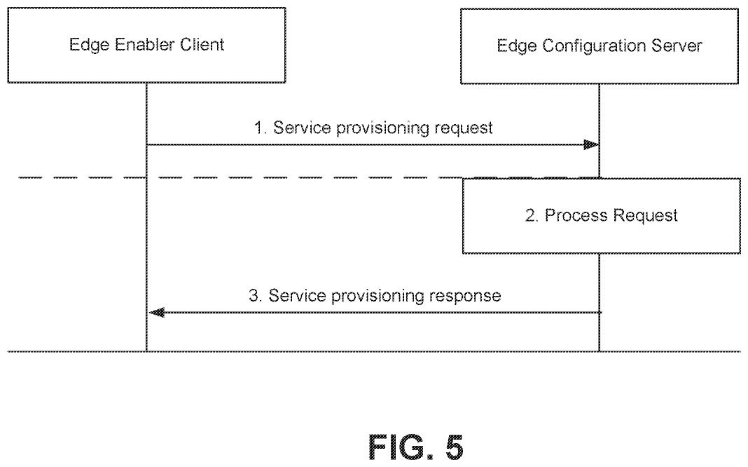

FIG. 5 illustrates an example mechanism for an application client to request provisioning from a prospective edge configuration server. For example, authorization and authentication may be performed in association with the application client requesting provisioning from a prospective edge configuration server. The authorization and authentication may be associated with enabling secure communication with an edge configuration server.

Certain system architectures (e.g., including terminal architectures) may refrain from allowing (e.g., not allow) highly computation-intensive applications to run (e.g., run optimally), for example, if/when using underlying HW resources (e.g., of the terminal device), which may affect the applications performance (e.g., rendering these applications unable to meet the performance requirements of a demanding service). These architectures may be improved, for example, by using (e.g., taking advantage of) hardware resources within the terminal device and/or hardware resources outside the terminal device.

A terminal device may be configured with a set of HW resources, which may include HW functionalities and/or features (e.g., constantly improving features). The terminal device may be configured to use (e.g., take advantage of) these HW resources by performing one or more of the following (e.g., the terminal device may be configured to perform one or more of the following): directly access HW resources (e.g., bypassing one or more software layers), access updated (e.g., better or improved) HW implementations of existing HW features, access new HW features from pre-existing apps, etc.

With respect to directly accessing HW resources (e.g., bypassing one or more software layers), certain architectures may restrict apps from accessing hardware directly. Such restriction may be imposed by enforcing an ABI interface (e.g., which may be the only way for apps to request access to a HW resource or HW operation). These architectures may provide multiple (e.g., two) protection modes: a user mode and a kernel mode. A process in the user mode may make a system call (e.g., as part of the ABI interface) to request the operating system to run a routine, for example, that is configured to be run in the kernel mode (e.g., such as one accessing HW). Enforcing the ABI may use an exceptional control mechanism (ECM). There may be multiple (e.g., four) classes of an ECM, including, e.g., Interrupt, Trap, Fault, and/or Abort. As an example, the trap mechanism may be used, for example, if/when an app makes a request to access a hardware resource through a system call.

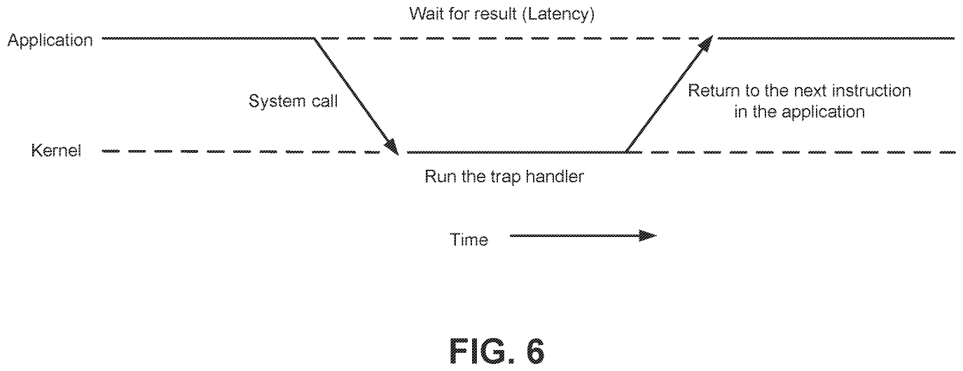

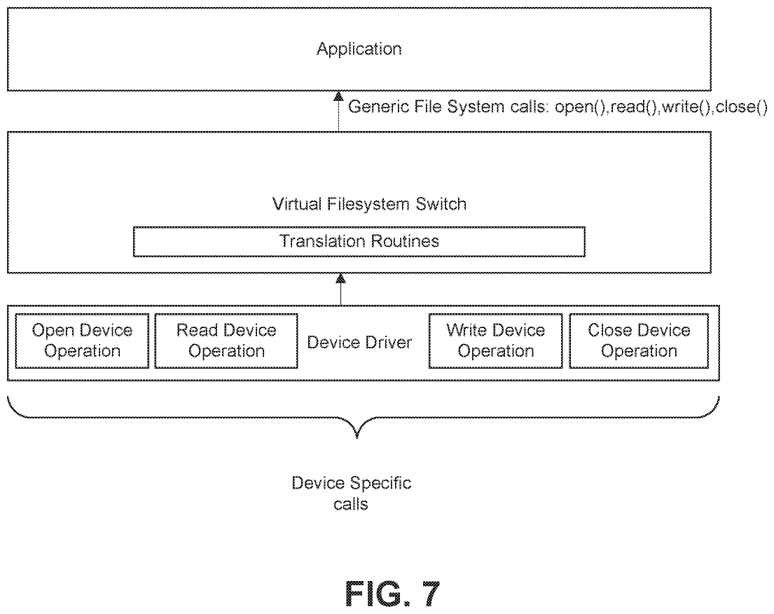

FIG. 6 shows example operations associated with a trap mechanism. As shown, if/when a system call is made (e.g., where the OS is configured to use the trap mechanism), control may be transferred to a trap handler, which may execute a trap handling routine from within the operating system kernel. Control may switch back to the next instruction of an application, for example, subsequently (e.g., once the trap handling routine is finished). A trap mechanism may enable (e.g., force) apps to use abstractions provided by the system calls of the operating system. The abstractions may be general (e.g., so that any application may use them), for example, such that the abstractions are not tailored to meet the specific requirements of an application. The algorithm(s) run by the trap mechanism to act on these abstractions may be general, for example, to explore a large search space. The space may be pruned, for example, to meet the needs of a specific application (e.g., because the pruned space may not include a solution that is relevant to the application). An abstraction (e.g., a general abstraction) used by apps to access hardware may include a file system abstraction. System calls (e.g., open( ), read( ), write( ), and/or close( )) may be provided to an app developer, for example, so that the developer may use the file system abstraction. FIG. 7 shows an example of file system abstraction that may be used to access HW devices.

Certain architectures may not enable an app to bypass the ECM and directly access HW resources. As a result, the app may experience (e.g., suffer from) multiplicative performance penalties. These architectures may provide (e.g., be limited to providing) a binary protection domain and may refrain from providing (e.g., not provide) additional protection domains, for example, to avoid the bloating of code that may result from supporting multiple execution paths (e.g., the bloated code may increase the footprint of an app running on a terminal device and decrease the performance of the terminal device).

With respect to accessing updated (e.g., better or improved) HW implementations of (e.g., existing) HW features, certain system call schemes (e.g., as described herein) may enable (e.g., require) an app developer to go through the system calls interface, for example, if/when an updated (e.g., better) HW implementation of (e.g., existing) features becomes available. This may be because some device drivers (e.g., new device drivers) for the HW may not be exposed directly to the app developer. The device drivers may be connected to the system call interface in the kernel of the operating system, which may force the app developer to pay the performance penalty of using the new implementation indirectly.

With respect to accessing new HW features from (e.g., pre-existing) apps, certain architectures may limit the way that an app accesses hardware (e.g., by making requests to the operating system through system calls). Using such system calls, an app may not be able to specify a particular feature of hardware that the app wants to use. These system calls may be accessed through a language API, which may not fully expose these calls. For example, system calls such as setegid( ) and seteuid( ) may not be available to app developers, and such HW features available to the app developers may be limited. In examples, HW features (e.g., new HW features), may remain inaccessible to app developers (e.g., app developers may not be able to directly exploit these HW features), for example, if/when the HW features (e.g., new HW features) offered by a device (e.g., such as crypto/AI accelerators, GPUs, etc.) are made available in the hardware.

A device architecture may use (e.g., take advantage of) hardware resources available outside the device (e.g., available at the edge of a network). Edge devices may be deployed by network operators and/or application level entities. Availability of HW resources may be increased near a consumer (e.g., terminal device resources may potentially be used to provide better user experience). One or more of the following may be addressed to take advantage of HW resources at the edge: concurrently accessing more than one hardware resource in a distributed edge environment, handling hardware resource failures, dealing with changing availabilities of edge HW resources as the user of a terminal device moves around, etc.

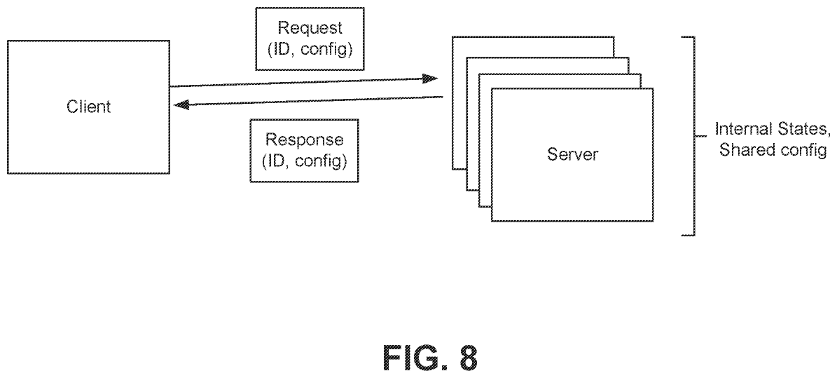

With respect to concurrently accessing more than one hardware resource in a distributed edge environment, certain techniques for deploying multiple servers (e.g., in clouds) to concurrently access multiple HW resources may synchronize the state of the HW resources (e.g., such as register values) across the servers to present a unified behavior. FIG. 8 shows an example of client-server interaction in the clouds. As shown, instances of client(s) and server(s) may share a configuration file between themselves. A (e.g., each) client instance may have a unique identifier associated with it. A (e.g., any) request by the client may be associated with this identifier and may be used to access correct data using an appropriate value in a register. This mechanism may result in latencies to service requests, for example, if a hardware resource (e.g., a new hardware resource) is added due to the initialization times involved in starting up the resource. If a hardware resource is removed, the current state of the registers (e.g., data associated with clients) may be saved and/or replicated elsewhere (e.g., in a different hardware resource). If the client is in the midst of a request, it may suffer added latencies as a result of the addition and/or replication.

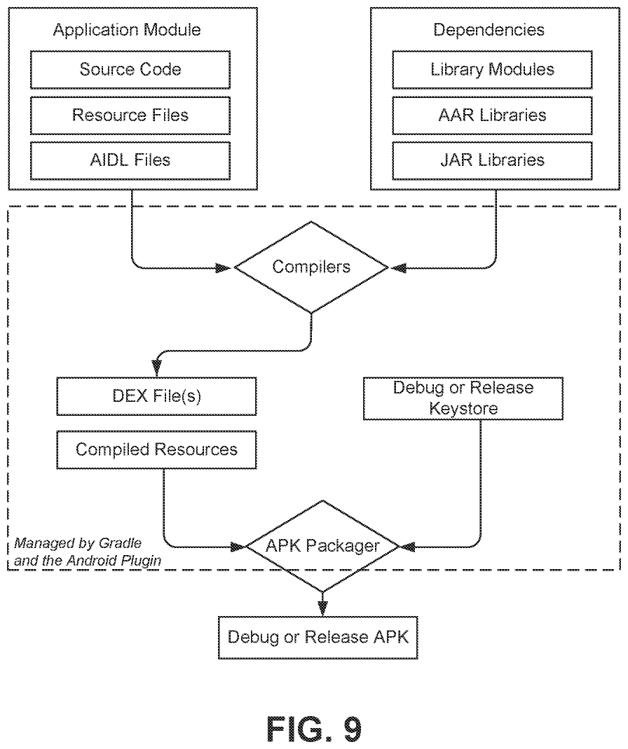

FIG. 9 shows an example app building mechanism in which functional modules may not be allowed to execute independently across HW resources. The modules may interact by sharing resources (e.g., such as resource files, library modules, AAR libraries, JAR libraries) that (e.g., all or a subset of the sharing resources) may be stored on the terminal HW running the app, for example, in the form of an APK (Android Package Manager) file, as shown in FIG. 9.

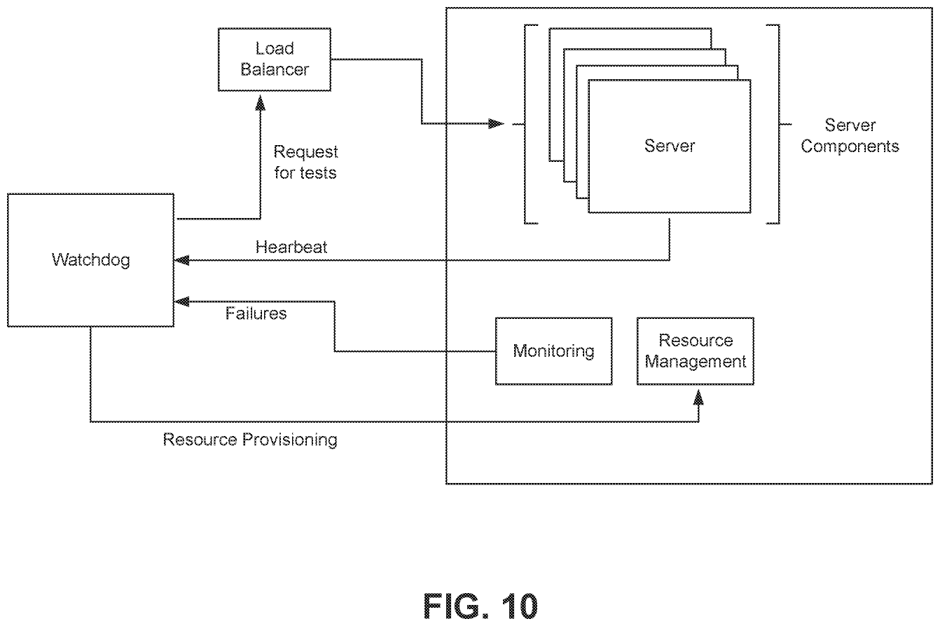

With respect to dealing with hardware resource failures, certain failure handling mechanisms in a client-server architecture may treat failures in the cloud and failures at the edge the same (e.g., not differentiate between failures in the cloud and failures at the edge). A watchdog mechanism may be used to manage the server side in the cloud, for example, as shown in FIG. 10. A watchdog component may use information from a server component (e.g., in the form of heart beats) and monitor information from the cloud platform to keep track of failures. The watchdog may (e.g., on its own) run tests on one or more components to check for failures. The watchdog may be feasible for (e.g., be limited to) components running on the cloud (e.g., in a data center) and may be infeasible in cloudlets (e.g., mini data centers) at the edge.

With respect to dealing with changing availabilities of edge HW resources as the user of a terminal device moves around, certain client-server mechanisms may be limited to performing server replication, for example, as illustrated in FIG. 10. These mechanisms may refrain from considering (e.g., not consider) the quality of service (QoS) provided by the HW resources (e.g., as seen from the client). As a result, (e.g., if/when users move around with their terminal devices) the mechanisms (e.g., in the cloud) may not be able to deal with fluctuating bandwidth, failure of links, and/or frequent changes in the logical communication associations between the terminals and HW resources available on the edge. Dealing with such volatility on the terminal itself may also be difficult.

With respect to discovering and obtaining access to remote HW resources, applications may discover, identify, and/or be authorized to access relevant HW, for example, prior to attempting the HW access. For example, an application client may be configured to access HW in an edge server (e.g., as shown in FIG. 4). The application client configured to access HW in the edge server may choose a server (e.g., correct server) where HW resources are available. The application client configured to access HW in the edge server may be authenticated and/or authorized to use these HW resources. The application client configured to access HW in the edge server may select specific resources from a remote host.

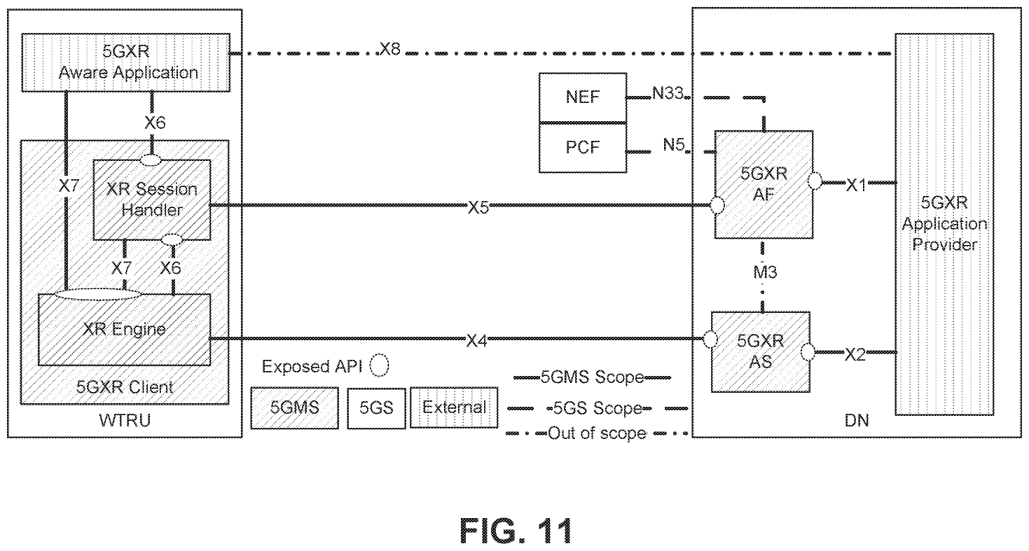

Combined access to remote and local HW resource may be supported. Applications such as extended reality (XR) may be integrated (e.g., into 5G systems). FIG. 11 shows an example 5G-XR client that may operate as a receiver of 5G-XR session data. The data may be accessed through one or more interfaces and/or APIs, for example, by an XR aware (e.g., 5G-XR aware) application. The client (e.g., 5G-XR client) may access an application function (AF) (e.g., 5G-XR AF), for example, through the interface (e.g., X5 interface). Such an AF (e.g., 5G-XR AF) may be dedicated to services (e.g., 5G-XR services). The client (e.g., 5G-XR client) may access an application server (AS) (e.g., 5G-XR AS), for example, through the interface (e.g., X4 interface). The AS (e.g., 5G-XR AS) may be an application server dedicated to services (e.g., 5G-XR services).

A client (e.g., 5G-XR client) may not be able to access the HW in a terminal device (e.g., a WTRU) or in a data network (DN). The client may not be able to access the HW in a terminal device (e.g., a WTRU) or in a DN, for example, if/when one or more XR applications using the client (e.g., 5G-XR client) may benefit from directly accessing the local and/or remote HW (e.g., to reduce the multiplicative performance penalties described herein).

A terminal device (e.g., such as a WTRU) may use (e.g., take advantage of) HW resources within the terminal device and/or on the edge, for example, to enable computation intensive applications (e.g., such as multi-player games and/or AR/VR applications) to run on the terminal device.

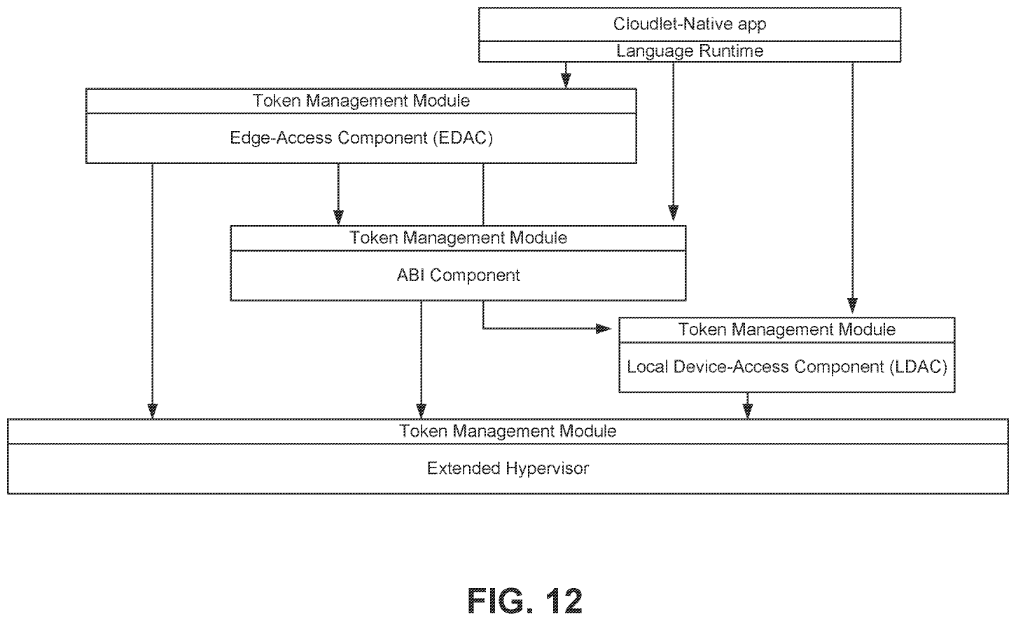

FIG. 12 shows an example of a terminal device architecture. The architecture may include one or more of a local device access component (LDAC), an edge device access component (EDAC), or a token management module (TMM). The LDAC may allow a software system (e.g., including apps or applications running on the terminal device) such as a cloudlet-native app to access HW resources on the terminal device. Cloudlet-native apps, software systems, software mechanisms, and/or software components may be used interchangeably herein. The EDAC may allow a software system to access HW resources on remote devices. The TMM may be an extension of a hypervisor. The TMM may be distributed across multiple components (e.g., all the components on the terminal device) and may control access to those components from an app.

The architecture may include an ABI component (e.g., which may be optional). The functionality of an operating system may be exposed through the ABI. Components associated with an app (e.g., only those components that are needed by the app) may be included in a unikernel (e.g., at compile time), as shown herein.

An app (e.g., operating within such an architecture) may directly access HW resources on a device, for example, using the LDAC (e.g., bypassing the ABI component). The app may access HW resources at the edge using the EDAC. The EDAC itself may directly access the ABI component, the LDAC, and/or the extended hypervisor. The ABI component may directly access LDAC and/or the extended hypervisor, e.g., as shown in FIG. 12. The architecture may offer a level of flexibility that is not available in other architectures.

An architecture may enable a terminal device to take advantage of hardware resources within the device, for example, to achieve optimal utilization of hardware resources in a distributed system. The device may directly access low-level hardware features of memory devices, input/output (I/O) devices (e.g., including network interface cards (NICs) and/or disks), ISAs of graphics processing units (GPUs), etc., for example, so that applications (e.g., cloudlet-native apps) may be able to process computation intensive tasks.

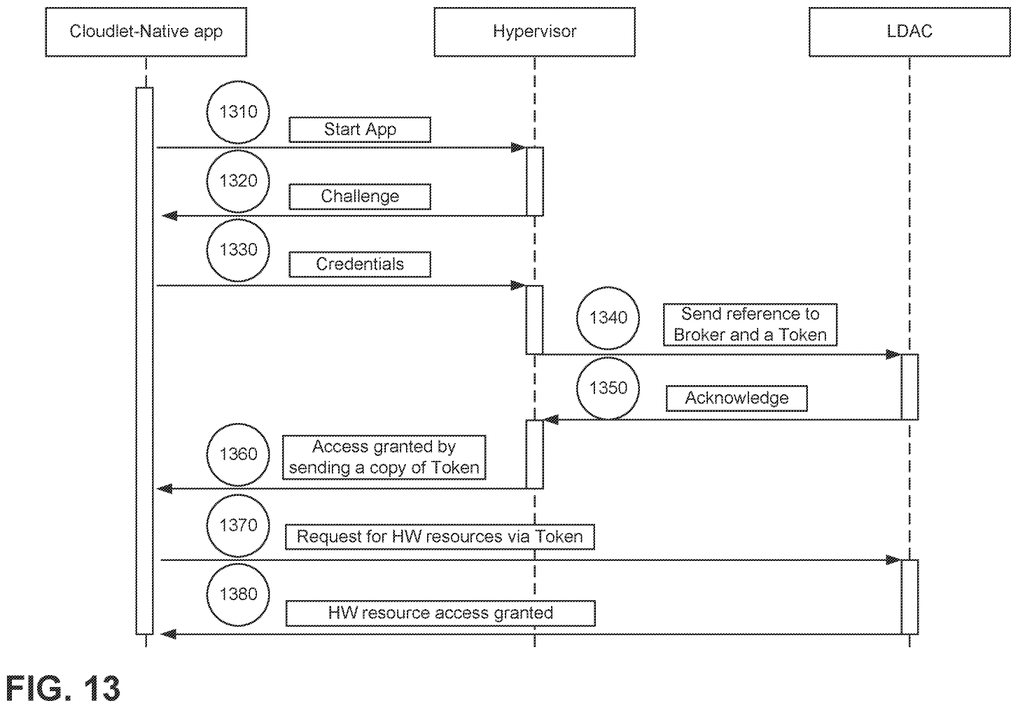

FIG. 13 shows example operations (e.g., which may be performed by a software system including an app or application) for getting permission to access local HW resources (e.g., via an LDAC). One or more of the following may be involved in the operations: an example software component (e.g., such as a cloudlet-native app), an LDAC, and/or an extended hypervisor. All or a part of the message exchange shown in FIG. 13 between the various components may be performed. At 1310, a user may request (e.g., via a software mechanism such as a cloudlet-native app) from a hypervisor permission to start. At 1320, the request may be challenged by a token management module of the hypervisor (e.g., the user may be asked to provide credentials). At 1330, the user may submit credentials. At 1340, the hypervisor may create a broker and send a reference associated with the broker (e.g., together with a token associated with the reference) to the LDAC (e.g., a token management module of the LDAC). At 1350, the LDAC may acknowledge receipt of the token, for example, to the hypervisor. At 1360, the hypervisor may send a message (e.g., with a copy of the token) to the app to signal that the requested access has been granted. At 1370, the user may send (e.g., via the software mechanism such as the cloudlet-native app) a request for HW access (e.g., in the form of the token) to the LDAC. At 1380, the LDAC may start sharing the HW resources in response to receiving the token. Once this access is granted, the software mechanism (e.g., the cloudlet-native app) may use the hardware resources programmatically, for example, through the LDAC.

One or more of the components described herein may be cloudlet-native components. A cloudlet-native app may include components that may directly access the hardware resources on a device (e.g., bypassing the operating system). The cloudlet-native app may (e.g., simultaneously) access hardware resources of one or more edge devices that may be running cloudlets (e.g., these cloudlets may include a small-scale data center running on an edge device). Cloudlet-native apps, software systems, software mechanisms, and software components may be used interchangeably herein.

One or more of the components (e.g., as described herein) may be local device access components. An LDAC may expose HW resources (e.g., low level HW resources) to other components. Low level HW resources may include but may not be limited to memory devices, I/O devices (e.g., including NICs and/or disks), ISAs of GPUs, etc. A (e.g., each) low level HW resource may be exported as multiple virtual HW resources, for example, using multiplexing techniques.

An LDAC may expose HW resources. An LDAC may be constructed out of multiple sub-components including, for example, a hardware provisioning module and/or a token management module. A hardware provisioning module (HPM) may enable software mechanisms (e.g., such as cloudlet-native apps) to directly access the system ISA (e.g., which may include system register operations), memory HW operations (e.g., translation lookaside-buffer, page-table registers, etc.), and/or fault and abort operations. The HPM may enable directly accessing I/O devices that may be a part of the system ISA (e.g., these I/O devices may be hidden by the operating system).

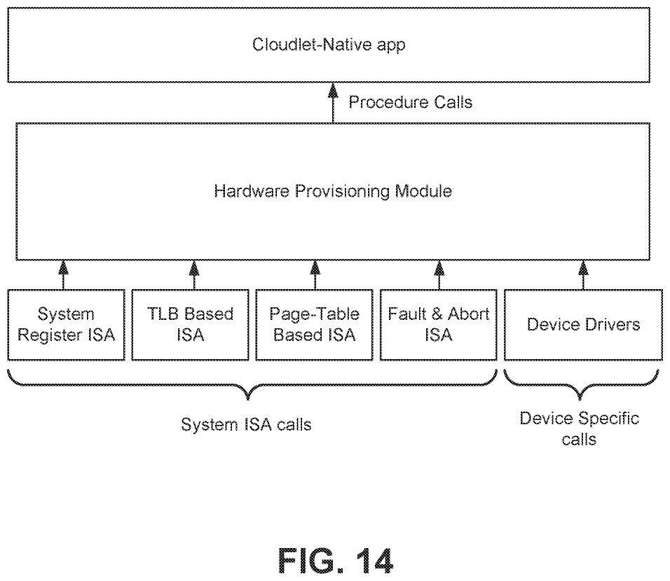

FIG. 14 shows example pass-by-reference semantics of an HPM. As shown, the HPM may provide access to the system ISA, for example, by encapsulating one or more ISAs (e.g., system ISAs) in a procedure call interface. The sub-classes of system ISA(s) that may be encapsulated (e.g., in procedure call interface) may include calls to system registers (e.g., a time stamp counter, an EFLAGS register, Control Register 3, etc.), calls to translation lookaside buffers (TLB), page tables, and/or calls for fault and abort conditions.

Lower-level HW primitives may include page-reference bits that may be hidden behind system calls. An LDAC may expose these primitives. The LDAC may expose these primitives to developers, for example, so that developers may construct higher-level primitives (e.g., such as software transaction memory). Using higher-level primitives may be more efficient than going through the system call interface.

Device drivers may provide device-specific functions (e.g., operations) associated with accessing a HW device. The HPM may pass functions or operations (e.g., device-specific functions or operations) by reference to apps, for example, through identifiers returned by calls to one or more procedures (e.g., as shown in FIG. 14). The behavior of the HPM may be different (e.g., semantically different) from the behavior of shim layers. For example, the HPM may refrain from changing (e.g., not change) operation arguments, handle an operation itself, or redirect the operation elsewhere (e.g., to a different operation).

One or more procedure calls may follow pass-by-reference semantics (e.g., as discussed herein) to export a system ISA call and/or a device-specific driver call to a cloudlet-native app. In pass-by-reference semantics, an identifier (e.g., such as a hardware defined identifier of a hardware operation) may be passed to a cloudlet native app, for example, if a corresponding procedure call returns successfully. This successful return may depend on the validity of token presented to the HPM by the cloudlet-native app as part of making the procedure call.

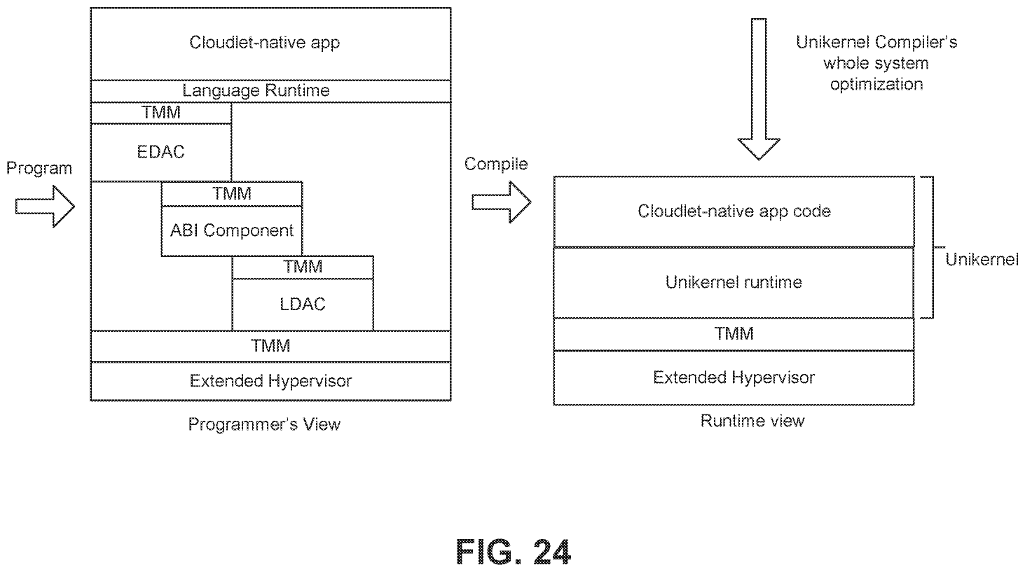

One or more procedure calls may form the basis of an application programming interface (API). Developers of a software mechanism or component (e.g., such as a cloudlet-native app) may use an API in their program(s), for example, to directly access hardware. For example, at the compile time of an app, the procedure calls (e.g., only the procedure calls) that may be used by the app may be retained (e.g., compiled) in the app and one or more (e.g., all) other procedures and/or their code may be discarded (e.g., not compiled, as shown in FIG. 24). This approach may be different from other approaches, for example, approaches where code (e.g., code that is not used or required) may be compiled into a binary or executable version of the app.

A terminal device architecture may include a token management module (TMM). An extended hypervisor may be configured to assume the role of a type 1 hypervisor, for example, by multiplexing hardware resources across various components. A type 1 hypervisor may run directly on hardware (e.g., rather than as an application of an operating system). The hypervisor may coordinate the mechanisms, functions, and/or operations of the token management module (e.g., as discussed herein).

The functionality of an LDAC and/or a hypervisor may be provided with a TMM (e.g., the TMM may enable the LDAC and/or hypervisor to participate in the mechanisms and/or operations discussed herein).

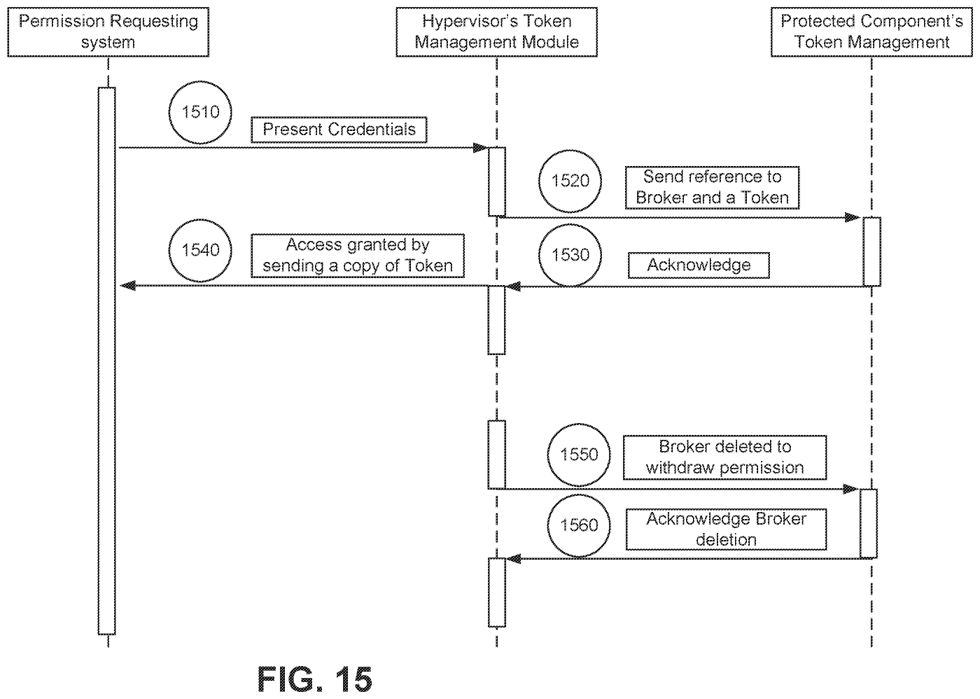

FIG. 15 shows example operations of a TMM to grant and/or withdraw an access request from a software system (e.g., an app or application) to a protected component (e.g., hardware and/or software components). Protected components may include, e.g., an LDAC, an EDAC, and/or an ABI. A software system making such a request may include a cloudlet native app. One or more of the operations shown in FIG. 15 may be performed. For example, at 1510, a software system may request permission from a hypervisor to access a protected component (e.g., by providing credentials of the software system). At 1520, the hypervisor may create a broker and send a reference to the broker and/or a token associated with the broker to the protected component's token management module. At 1530, the protected component may acknowledge the receipt of the token to the hypervisor. At 1540, the hypervisor may send a message (e.g., with a copy of the token) to the software system, for example, to signal that the requested access has been granted. At 1550, the hypervisor may withdraw (e.g., decide to withdraw) the permission to access the protected component. The hypervisor may delete the broker referenced by the protected component and/or inform the protected component, for example, if the hypervisor withdraws (e.g., decides to withdraw) the permission to access the protected component. At 1560, the protected component may acknowledge the withdrawal of the permission (e.g., the token that is still with the permission requesting system may no longer be valid).

For example, (e.g., using the architecture and/or techniques described herein) a software component, system, or mechanism (e.g., a multi-player gaming app) that requests access to HW resources may refrain from making (e.g., not need to make) a system call to the operating system. The software component, system, or mechanism may avoid switching to the kernel to run a trap handling routine that may perform general operations (e.g., use a general algorithm) to explore (e.g., irrelevant) solution spaces.

The kernel of the operating system may include a module seeking protection, for example, with system calls. With a TMM, a module may execute in its own protection domain (e.g., with a TMM) that may be mediated by a token. EDAC, LDAC, and/or ABI modules may be accessed by a software system (e.g., such as a cloudlet-native app running in user space) using the token and/or utilizing a (e.g., any) combination of low or high-level abstractions offered by these modules (e.g., which may not be possible in systems where low-level abstractions may be hidden behind system calls). App developers may have the flexibility of using a combination of interfaces, for example, such as ISA (e.g., offered by a hypervisor, an LDAC, etc.), ABI (e.g., offered by an ABI component), API (e.g., offered by a language-runtime and/or an ABI component), device drivers (e.g., offered by an LDAC), and/or abstractions to access HW resources outside the terminal (e.g., offered by an EDAC).

A unikernel may be supported and/or implemented, for example, so that the parts of an LDAC (e.g., only those parts of the LDAC) that are associated with the operation/functionality of a software system or software component (e.g., an app or application) may be compiled with that software mechanism or software component (e.g., as shown in FIG. 24 below). The system may switch to a kernel mode to run a routine (e.g., a trap routine, for example, where a trap may be an exception that is triggered (e.g., by hardware), e.g., if/when an application makes a system call) that performs general operations (e.g., run general algorithms) to search irrelevant solution spaces (e.g., in a system or architecture that does not utilize a unikernel), for example, if a request is made to access hardware. For example, control may pass to a routine (e.g., trap handling routine) which may be running in the operating system's kernel. Latencies may occur when access to hardware is requested, for example, if the unikernel techniques described herein (e.g., in software mechanisms such as gaming apps) are not used.

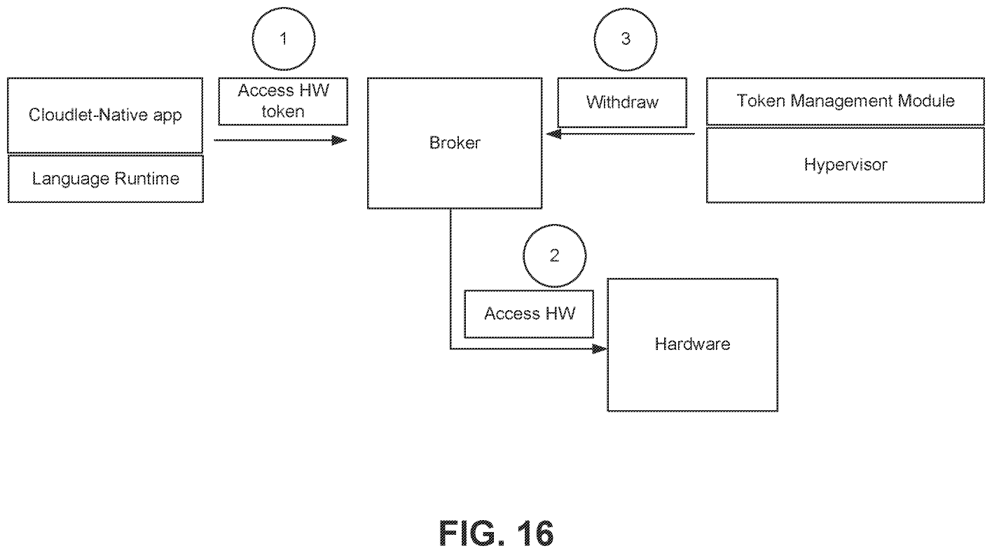

FIG. 16 shows example operations that may be performed by a permission module of a hypervisor to withdraw a permission token for a hardware resource from a software component (e.g., an app). The implementation (e.g., internal implementation) of the permission token within the hypervisor may be associated with a broker component. The hypervisor may disable the broker component (e.g., making the associated token redundant), for example, to withdraw the permission.

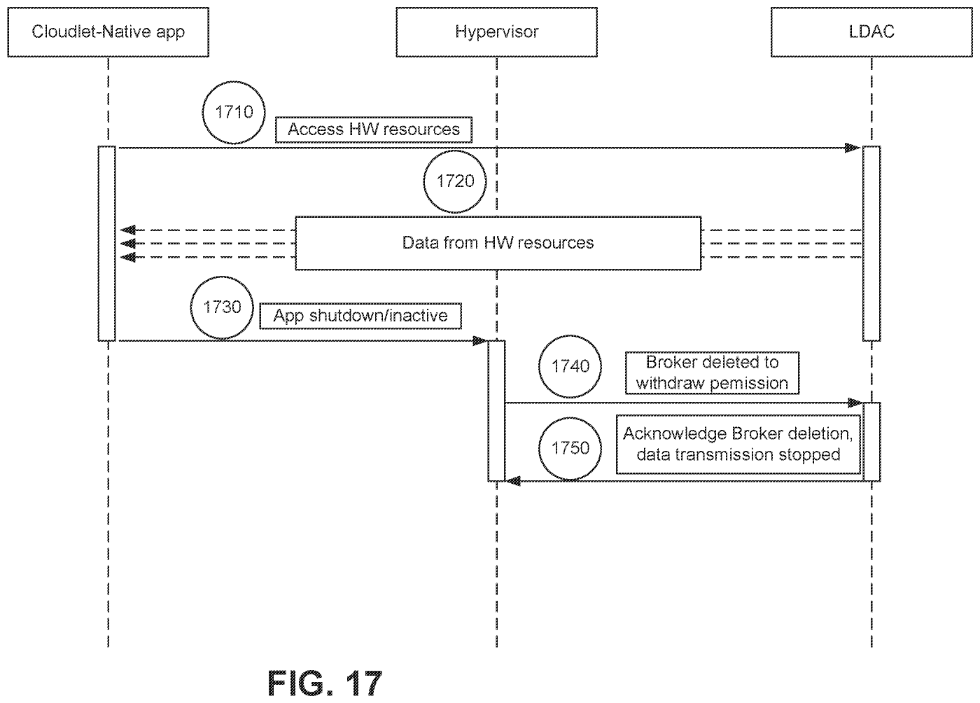

A software system (e.g., such as a cloudlet-native app) may use a sequence of messages (e.g., as shown in FIG. 13) to request access to the HW resource, for example, to directly access a HW resource. FIG. 17 shows an example message exchange that may occur between a software system, a hypervisor, and/or an LDAC, e.g., if access to the HW resource is granted. One or more of the messages shown in FIG. 17 may be transmitted and/or received (e.g., without switching to a trap mechanism or routine that runs general algorithms). As shown at 1710, the software system such as the cloudlet-native app may start (e.g., call up) a low level HW operation to access a HW resource. Examples of such operations may include, for example, requests for TLB access, requests for page table access, etc. As shown at 1720, the requested resource (e.g., requested data from the HW resource) may be returned by the LDAC to the software system. As show at 1730, the software system may be shut down by a user or may be inactive for a certain time interval (e.g., as set by the hypervisor parametrically). As shown at 1740, the hypervisor may disable an access token (e.g., by deleting the broker associated with it) and/or may inform the LDAC about the disablement. The hypervisor may disable the access token and/or may inform the LDAC about the disablement, using a mechanism (e.g., as described herein with respect to FIG. 15). As shown at 1750, the LDAC may acknowledge the disablement of the token (e.g., via broker deletion) and/or may inform the hypervisor that the data transfer has been stopped.

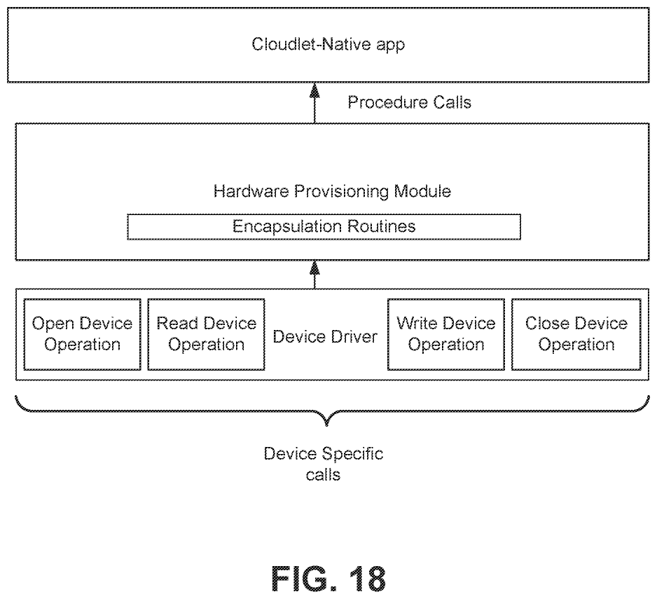

With respect to accessing updated (e.g., improved) HW implementations of (e.g., existing) HW features, FIG. 18 shows an example hardware provisioning module (HPM) (e.g., as part of an LDAC) that may provide a set of encapsulation routines. These routines may pass (e.g., by reference) device driver operations to a software system such as a cloudlet-native app (e.g., by a one-one onto mapping) to the procedure calls exported by the HPM. The software system may call the device operations directly, for example, if the software system receives this reference. The encapsulation routine may receive and/or use a token as a parameter. The token may be verified by a TMM (e.g., using the broker mechanism described herein), for example, before access to the procedure calls exported by HPM may be granted.

A translation mechanism (e.g., as described herein with respect to FIG. 7) may have a running time (e.g., an average running time) that is greater than a constant time (e.g., O(1)). The HPM may have an encapsulation mechanism with a lookup time equal to the constant time (e.g., O(1)).

The implementation of HW operations (e.g., as shown in FIG. 18) may be replaced, for example, if/when an updated (e.g., better) HW implementation of existing HW features becomes available. The implementation of HW operations (e.g., as shown in FIG. 18) may be replaced, for example, to keep the one-one onto mapping between the interfaces of the device drivers (e.g., as represented by the HW operations) unchanged.

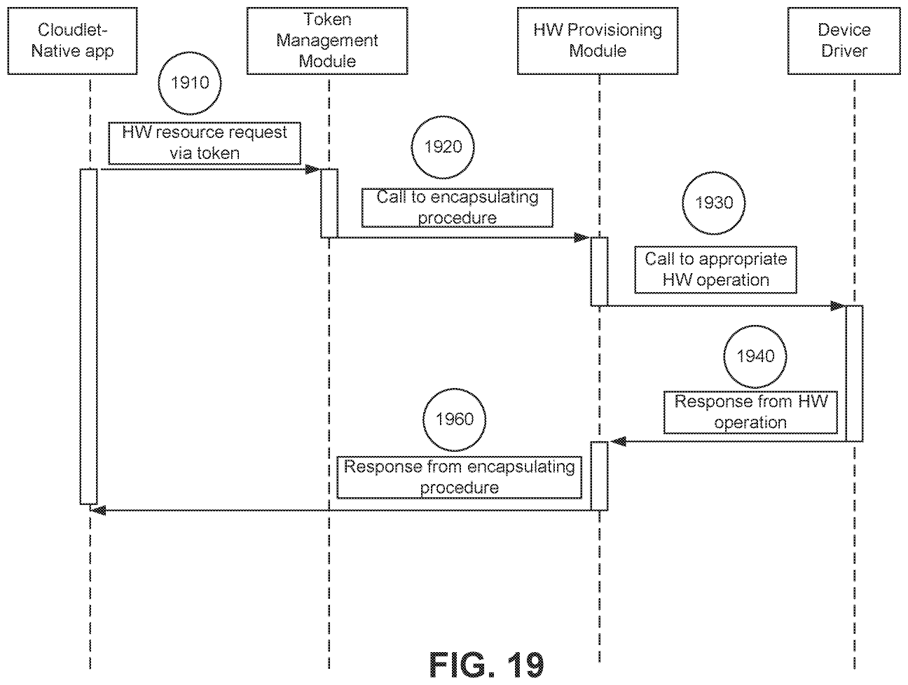

Messages may be exchanged between a software system (e.g., like a cloudlet-native app), the modules (e.g., two modules) of an LDAC, and/or a device driver, for example, to access updated (e.g., better) HW implementations of (e.g., existing) HW features. As discussed herein, the LDAC may include a token management module (TMM) and/or a HW provisioning module (HPM). One or more messages shown in FIG. 19 may be exchanged. For example, as shown at 1910, an app may send a request to access a HW resource, for example, by passing a token via an encapsulating procedure. At 1920, the TMM (e.g., of an LDAC) may check the token to determine whether it is valid. The TMM (e.g., of an LDAC) may allow the call to the encapsulating procedure exported by the HPM, for example, if the token if valid. As shown at 1930, the HPM may map the encapsulating procedure to a HW operation and may call (e.g., initiate) that operation. As shown at 1940, the device driver may execute the HW operation and may send a response to the HPM. As shown at 1950, the HPM's encapsulating procedure may return the response to the app.

Domain specific architectures (DSA) (e.g., such as GPUs, processors for software defined networks, neural network processors, etc.) may become available. These DSAs may accelerate applications, for example, such as those associated with parallel data processing with an instruction (e.g., a single instruction). The DSAs may accelerate applications in a manner that may not be possible with a CPU having a general-purpose architecture. These DSAs may be Turing complete and/or universally programmable (e.g., in comparison to application specific integrated circuits (ASICs) that may be designed for a specific or single functionality). The features of these DSAs may be exposed through domain specific languages (DSL), for example, such as MATLAB, TensorFlow, P4, Halide, etc. These DSL may expose the HW features (e.g., new HW features) of DSAs, for example, by mapping higher level vector and/or matrix operations to the HW features. The DSLs may not bypass the system call interface of an operating system.

HW features (e.g., new HW features) may be supported by HW vendors. An API may be provided to expose these features as operations. The API may be expressed in a DSL as explained herein. An HPM may encapsulate the HW operations (e.g., in procedures) and may export them, for example, using the pass-by-reference semantics (e.g., as described herein with respect to FIG. 14). Architectures in which HW operations (e.g., new HW operations) are hidden by the operating system behind system calls may not allow software systems (e.g., such as cloudlet-native apps) to access those HW operations.

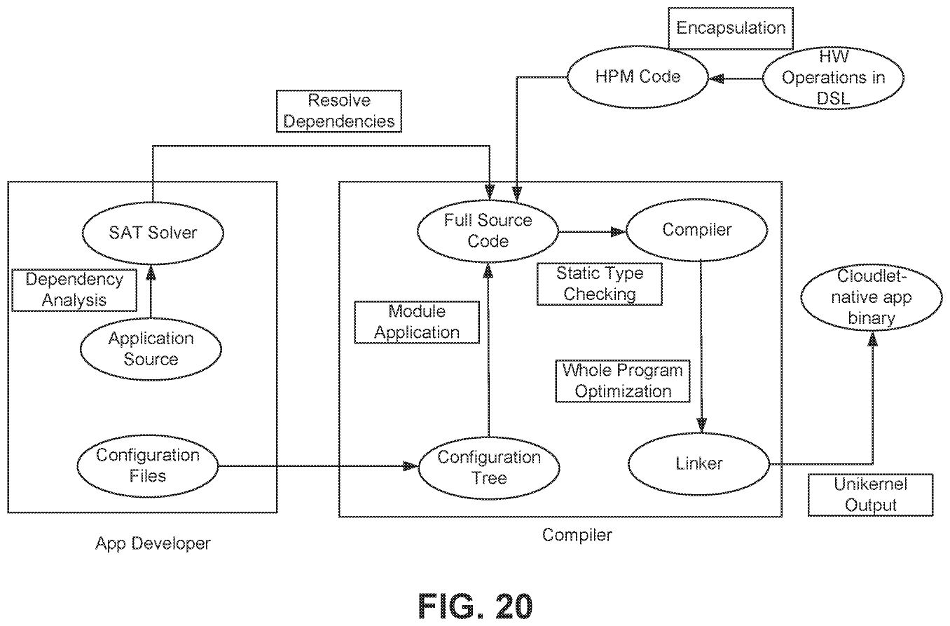

FIG. 20 illustrates how the encapsulation of HW operations (e.g., new HW operations) in a DSL by the procedure(s) of HPM code may be integrated with a workflow used by a software system developer (e.g., such as a cloudlet-native app developer). The app developer may call a procedure (e.g., a new procedure) of the HPM that may pass (e.g., by reference) one or more HW operations (e.g., one or more new HW operations). The app developer may specify one or more files (e.g., configuration files) that may be associated with the app. A satisfiability (SAT) solver component may resolve one or more dependencies, for example, by combining the HPM code with the app developer's code into (e.g., full) source code. The module(s) (e.g., various modules) written by the app developer and/or the module(s) that may be added to resolve dependencies may be statically resolved by a compiler. The compiler may perform program optimization (e.g., a whole program optimization), for example, by removing components that are not used by the app. The remaining components (e.g., after removing components that are not used by the app) may be linked together (e.g., by a linker), and the cloudlet-native app may be output as a unikernel binary.

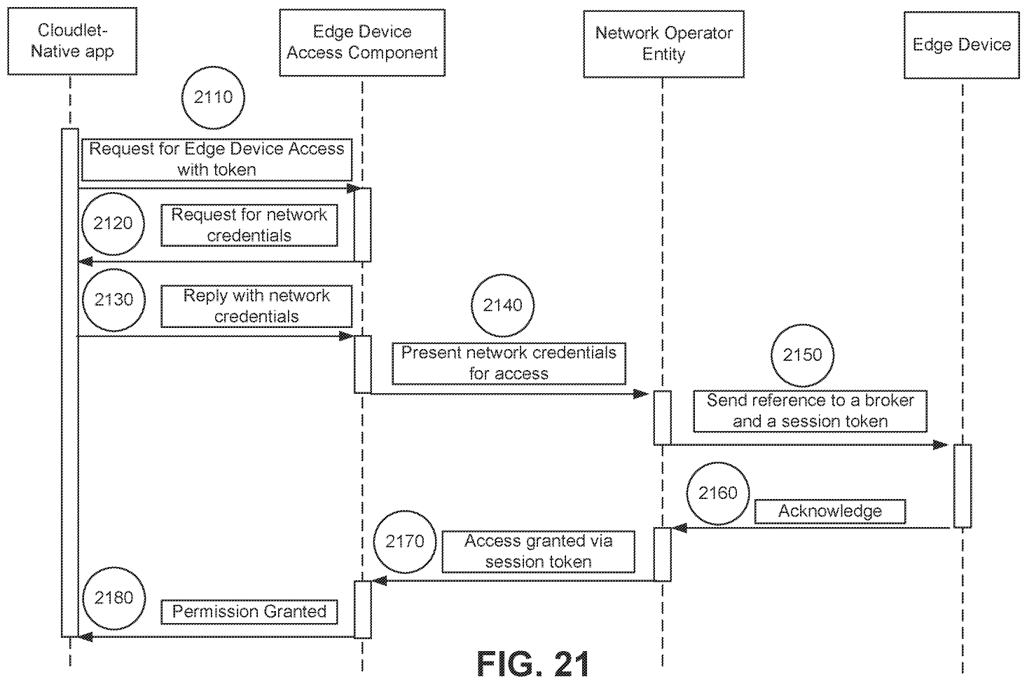

Hardware resources outside a terminal device (e.g., at the edge of a network) may be utilized. FIG. 21 shows example operations and/or message exchange that may be performed by a software system (e.g., such as a cloudlet-native app) to start accessing HW resources (e.g., data) from an edge device. An edge device access component (EDAC) may be included, for example, to provide programming abstractions for accessing HW resources outside the terminal device (e.g., from devices at the edge of a network). The EDAC may act as a proxy layer that shields applications from the complexity of a network (e.g., in terms of topology and/or HW availability), for example, by implementing relevant infrastructure on the terminal device. Examples of abstractions that may be provided include (but are not limited to) remote procedure calls (RPC), transaction processing (TP) monitors, message brokers, service-oriented architectures (SOA), etc. The EDAC may (e.g., if/when acting as a proxy for a client application) play the role of a client in its interactions with a network operator entity (e.g., as discussed herein). The EDAC may (e.g., to provide the programming abstractions and/or play the role of a client in the network interactions) implement the relevant infrastructure internally. The infrastructure may include (but is not limited to) compilers for the programming abstractions, token management, marshalling and unmarshalling of data, fault tolerance, and/or traffic management.

A network operator entity (NOE) (e.g., which may be implemented as a software component) may be included and/or owned by a network operator to provide secure access to infrastructure services, for example, such as authorization and/or authentication for an edge device. The NOE may be placed on the edge device itself or another location (e.g., anywhere), for example, that the network operator may deem optimal. The NOE may be responsible for state management, which may allow clients and servers to run in a stateless fashion. In some cases (e.g., within stateless components), the code for concurrent access of resources may not require specification of the order in which access may be requested. In some cases (e.g., within stateful components), the specification of access order and/or consequent concurrency management schemes may be performed. For example, the stateless approach may be used in serverless computing.

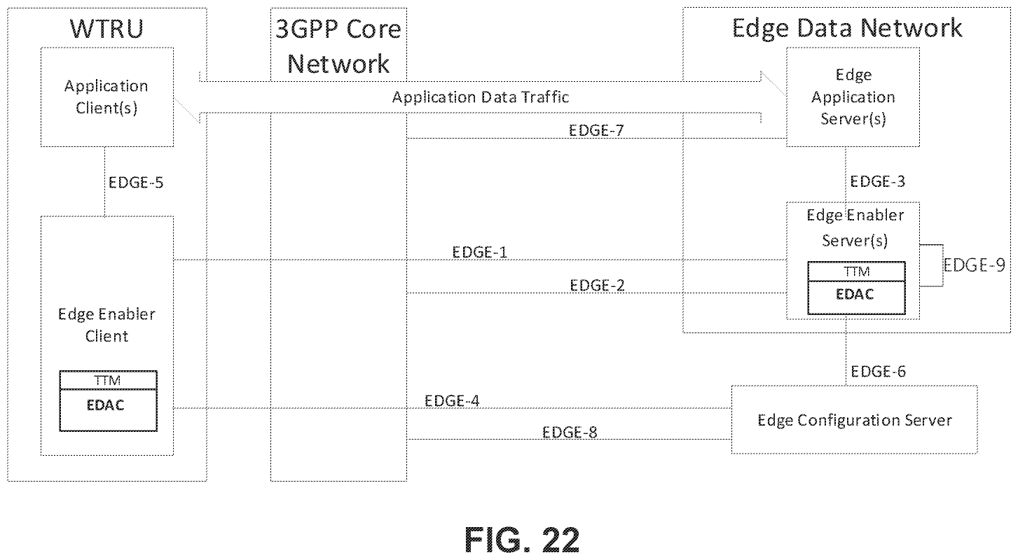

An edge device may be included to provide HW resources to an (e.g., any) authenticated and/or authorized entity. These resources may include, e.g., computing devices, memory, etc. FIG. 22 shows an example mechanism (e.g., a remote mechanism) for accessing infrastructure resources (e.g., as described herein). An edge enabler (e.g., an edge enabler client) may be included in a terminal device. The edge enabler may implement components/functionality of the TMM and/or EDAC (e.g., as described herein), for example, to use (e.g., take advantage of) the techniques described herein.

The operations associated with accessing infrastructure resources from an edge device may be illustrated in FIG. 21. An app accessing the infrastructure resources may have already been issued credentials (e.g., in accordance with the operations shown in FIG. 13). In an embodiment of such credentials, the app may be issued a token that enables the app to request access (e.g., further access) to infrastructure resources through the EDAC.

The app may request/obtain a session token to access the edge device, e.g., via one or more of the operations shown in FIG. 21. The session token may be an additional token to the token that enables the app to access infrastructure resources through the EDAC.

As shown in FIG. 21 at 2110, the app may request an EDAC component to access the edge device (e.g., by presenting the app's permissions token). As shown at 2120, the EDAC may request the app to provide network credentials, for example, if the permissions token is determined to be valid. As shown at 2130, the app may respond by sending its network credentials to the EDAC. As shown at 2140, the EDAC may present the network credentials of the app to the NOE. As shown at 2150, the NOE may create a broker and/or a session token, for example, if the network credentials are determined to be valid.

The NOE may send a message to the edge device with a reference to the broker along with the session token. The issuing network entity may revoke the token, for example, by disabling the broker (e.g., similar to what a hypervisor would do using the semantics of FIG. 16). As shown at 2160, the edge device may acknowledge the creation of the broker. As shown at 2170, the network operator entity may create the session token associated with the broker and may send the token to the EDAC. As shown at 2180, the EDAC may (e.g., upon receiving the session token) signal to the app that the HW resource(s) at the edge device is available.

The permissions token described herein may be issued by a hypervisor on a device. The sessions token described herein may be issued by an entity of a network operator.

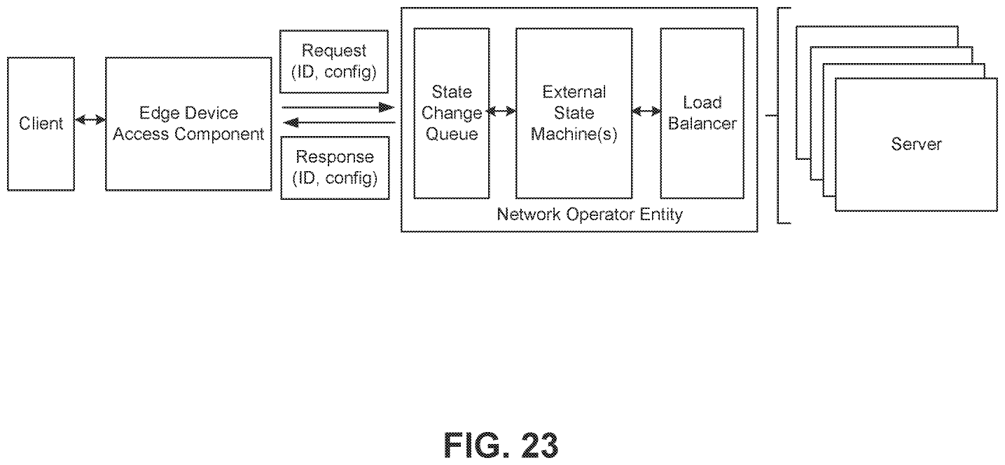

More than one hardware resource may be accessed (e.g., concurrently accessed) in a distributed edge environment. Latencies associated with the access (e.g., if/when a new HW resource is added or an old resource is removed) may be reduced or eliminated. A state may be stored separately from HW resources. The functionalities of a HW resource may be accessed in a stateless manner. The functionalities of a HW resource may be added and/or removed without managing the state associated with the HW resource and/or the functionalities. The state described herein may include a session state, the state of application data, etc. FIG. 23 shows an example scheme in which clients and servers may include stateless components. The state may be handled by a NOE (e.g., which may be a software component), as described herein. The NOE may maintain a queue of computations triggered by a client or server that may result in state change(s). This queue may be used to update an external state machine(s) within the NOE. The state changes may correspond to an execution of a function on the server or the client. A load balancer component may execute the state changes on the server or the client depending on whether the state changes correspond to an execution of a function on the server or on the client.

Functions may be executed by respective servers in an arbitrary order (e.g., in any order) without affecting the result of the execution (e.g., in accordance with the Church-Rosser theorem). This may be because, for example, the functions are stateless. A software system (e.g., such as a cloudlet-native app) may access (e.g., concurrently) more than one HW device to run different functions, for example, without specifying the order in which those functions are run. This may simplify the development of apps that may concurrently access more than one HW resource in a distributed edge environment.

An architecture may allow a software system (e.g., such as a cloudlet-native app) to be packaged into a unikernel, for example, to allow one or more modules (e.g., on the client side) to execute independently across HW resources. FIG. 24 shows an example of packaging a cloudlet-native app into a unikernel. An app developer may partition an app into multiple components (e.g., components that play the role of client(s) and server(s)). A client component that runs on a terminal device may be compiled with one or more of an LDAC, an ABI component, or an EDAC, for example, by a unikernel compiler. The compiler may add the parts of the LDAC, ABI Component, and/or EDAC that may be used by the client component of the app.

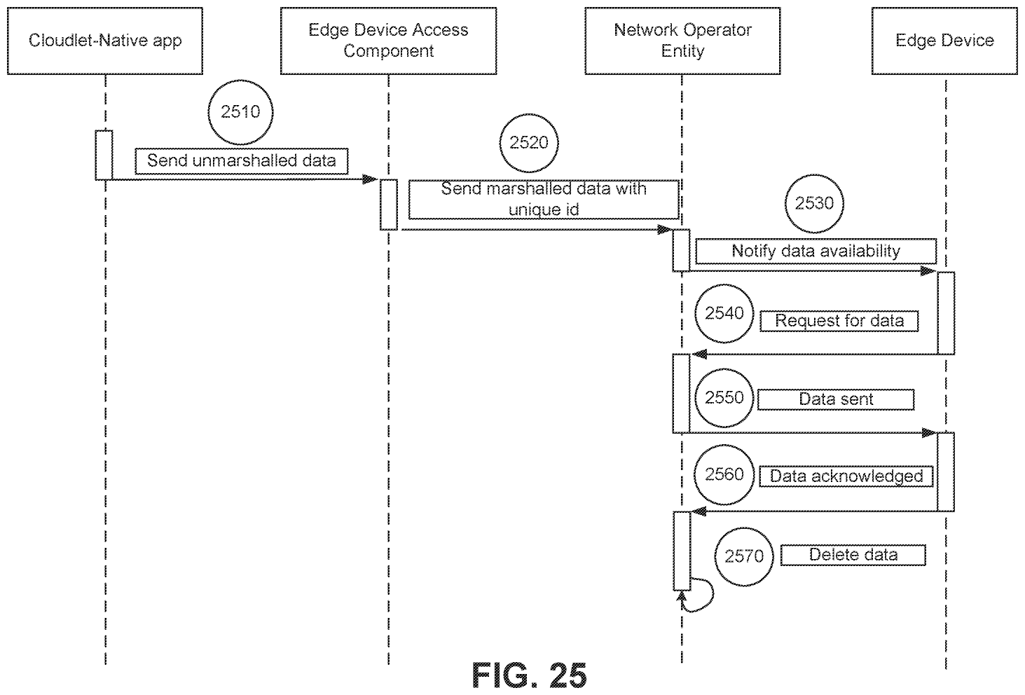

FIG. 25 shows example operations that may be performed to send data from a software system such as a cloudlet-native app to an edge device. As shown at 2510, the app may send data (e.g., unmarshalled data) to an EDAC. As shown at 2520, the EDAC may marshal the data and send the data to a network operator entity (NOE), for example, with a unique id. This unique id may be, for example, a session token. As shown at 2530, the NOE may notify the edge device of the availability of data. As shown at 2540 (e.g., upon receiving the notification), the edge device may make a request for data. As shown at 2550, the NOE may respond by sending the requested data. As shown at 2560, the edge device may acknowledge receipt of the data. As shown at 2570, the data may be deleted by the NOE, for example, if/when the NOE receives the acknowledgement from the edge device or if/when a timeout event occurs.

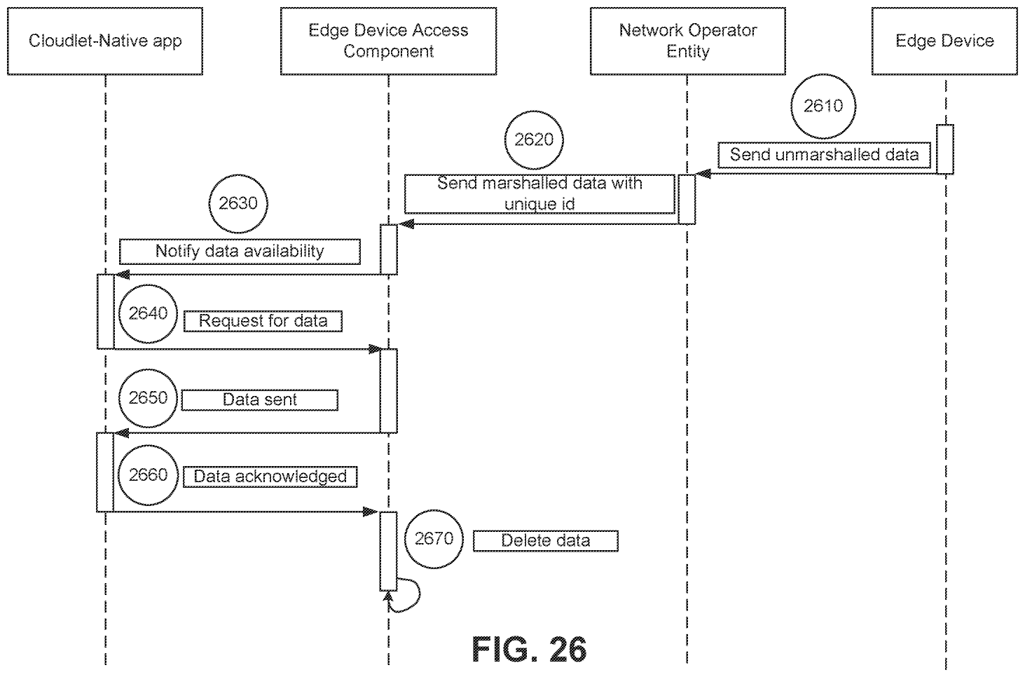

FIG. 26 shows example operations that may be performed to send data from an edge device to a software system such as a cloudlet-native app. As shown at 2610, the edge device may send unmarshalled data to a NOE. As shown at 2620, the NOE may marshal the data and send it to an EDAC, for example, with a unique id. This unique id may be, for example, a session token. As shown at 2630, the EDAC may notify the cloudlet-native app of the availability of data. As shown at 2640 (e.g., upon receiving the notification), the cloudlet-native app may make a request for data. As shown at 2650, the EDAC may respond by sending the requested data. As shown at 2660, the cloudlet-native app may acknowledge receipt of data. As shown at 2670, the data may be deleted by the EDAC, for example, if/when the EDAC receives the acknowledgement from the cloudlet-native app or if/when a timeout event occurs.

A NOE may maintain (e.g., multiple) copies of a stateless function on (e.g., multiple) edge devices, e.g., to deal with failed HW resources at the edge. The NOE may store the state of a computation itself separately (e.g., as shown in FIG. 23). An edge device may be replaced by another HW device running the code of the function, for example, if the HW edge device fails. The NOE may use the latest state it has and/or the function stored on the other HW device to proceed with the computation associated with the function.

An EDAC may forward one or more client requests with an appended id to the NOE, for example, to let the client communicate with an edge device. The NOE may use this id to update the state of computation maintained by the NOE and/or to order the steps of the computation. This id may be unique and may include a session token. The NOE may run the stateless function on a designated device and may associate the results produced by the function with the state of the computation using the unique id, for example, in case of HW failure.

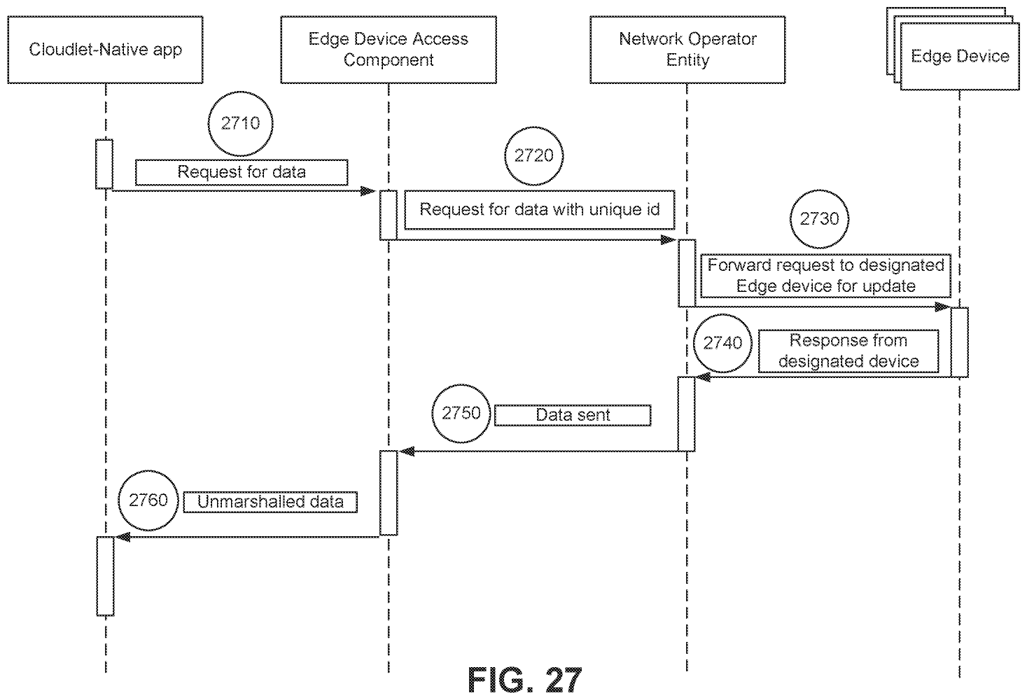

FIG. 27 shows example operations that may be performed to handle failures of HW resources. As shown at 2710, a software system (e.g., such as a cloudlet-native app) may send a request for data to an EDAC. As shown at 2720, the EDAC may append the request with an id and send the request to a NOE. This id may be unique and may include a session token. As shown at 2730, the NOE may forward the request to a designed edge device (e.g., a newly designated edge device) for computation. As shown at 2740, the designated edge device may return the result of the computation to the NOE. As shown at 2750, the NOE may update the state of the computation that it maintains, for example, using the result it receives from the edge device and the id. The NOE may send the resulting data to the EDAC. As shown at 2760, the EDAC may unmarshall the data and send it to the cloudlet-native app.

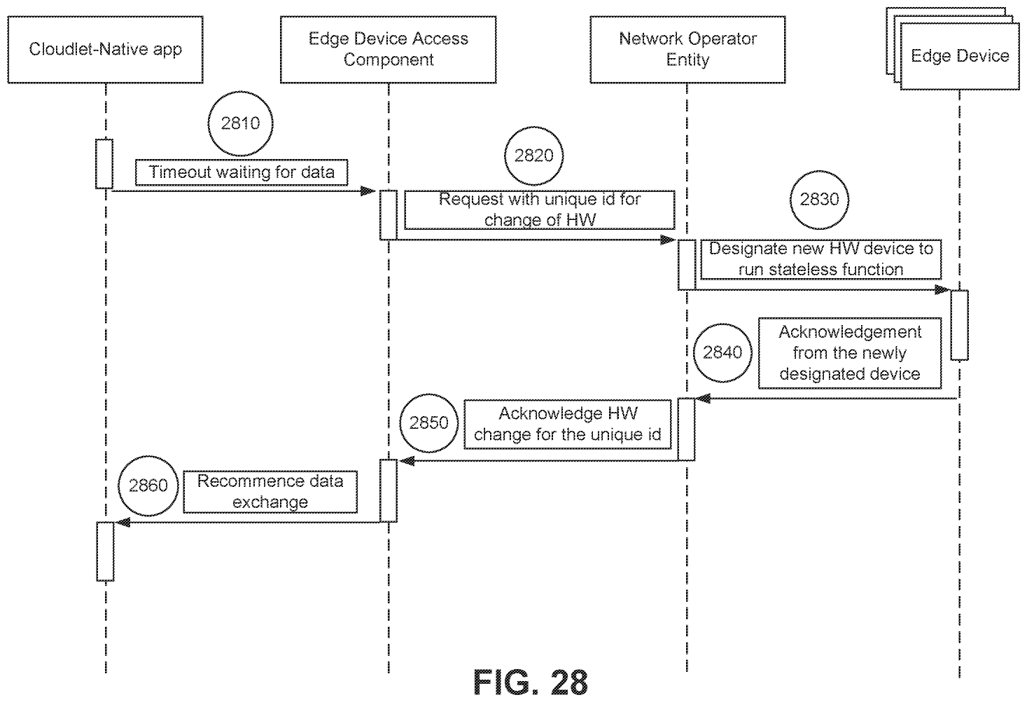

Changing availabilities of edge HW resources may be handled as the user of a terminal device moves around. A client's quality of service (QoS) may vary as the user of a device that hosts the client moves around. FIG. 28 shows example actions that may be initiated by the client, for example, if the QoS of the data received by the client is low or if the client times out while waiting for new data. In these situations, an NOE may switch to an alternative (e.g., new) HW resource to run a stateless function. As shown in FIG. 28 at 2810, a software system (e.g., such as a cloudlet-native app) may send a message to an EDAC, for example, signaling that the software system has timed out (e.g., while waiting for data) or that the QoS of the data is poor. As shown at 2820, the EDAC may send a message to the NOE with a unique ID of a failed request for a change of HW resource(s). The unique id may include, for example, a session token. As shown at 2830, the NOE may switch to (e.g., designate) an alternative (e.g., new) HW resource (e.g., such as an alternative edge device), for example, by making the alternative edge device run a stateless function. As shown at 2840, the alternative/designated device may send an acknowledgment to the NOE, for example, confirming that it is now running the stateless function. As shown at 2850, the NOE may inform the EDAC that the switch to the alternative HW resource (e.g., the alternative edge device) has been made, and the NOE may reference the ID of the failed request. As shown at 2860, the EDAC may send a message to the cloudlet-native app, for example, to recommence data exchange.

Remote HW resources may be discovered. Access to remote HW resources (e.g., discovered remote HW resources) may be obtained. Mechanisms and/or techniques may be provided to enable an application to find a suitable host that may provide HW resources. For example, an application level mechanism may be provided to configure an application (e.g., a client) to access remote resources. Such an application may include an edge enabler client (EEC). The EEC may be pre-configured to discover the address of an edge configuration server (ECS), e.g., by hardcoding the uniform resource identifier (URI) of the ECS. A mobile network operator (MNO) may enable configuration of an EEC, for example, through one or more network (e.g., 5G core network (5GC)) procedures.

The configuration of an EEC (e.g., by an MNO) may include the EEC requesting a modem in a terminal device (e.g., a WTRU) to provide an indication to a network (e.g., 5GC) indicating that the EEC is capable of supporting MNO configuration. The network (e.g., responsive to the provision of the aforementioned indication) may derive ECS information (e.g., such as a fully qualified domain name (FQDN) and/or IP Address(es) of the ECS), for example, based on subscription information associated with the terminal device.

An application may make LDAC and/or EDAC services (e.g., which may be embodied within an EEC) available for accessing specific HW resources, e.g., at the edge of a network. In examples (e.g., to enable the selection of an edge hosting environment where such HW resources may be located), an application identifier (ID) (e.g., of the application that is requesting access to HW) or an (e.g., any) identity that uniquely identifies the HW resources that may satisfy the needs of an application may be provided. Such an application ID or HW resource identity may be provided, for example, instead of or in addition to an indication that an EEC is capable of receiving additional configuration information to trigger the network (e.g., 5GC) to provide ECS address(es).

The application ID or HW resource identity (e.g., as described herein) may be tailored to signal HW requirements. The EEC may obtain generic information (e.g., from a central server), for example, to help build the ID or identity. The EEC may use additional inputs, such as a current context, an inferred user intent, and/or specific application context (e.g., the number of players in a game) to construct an application ID that may be matched by the network (e.g., 5GC), for example, if/when an ECS is selected.

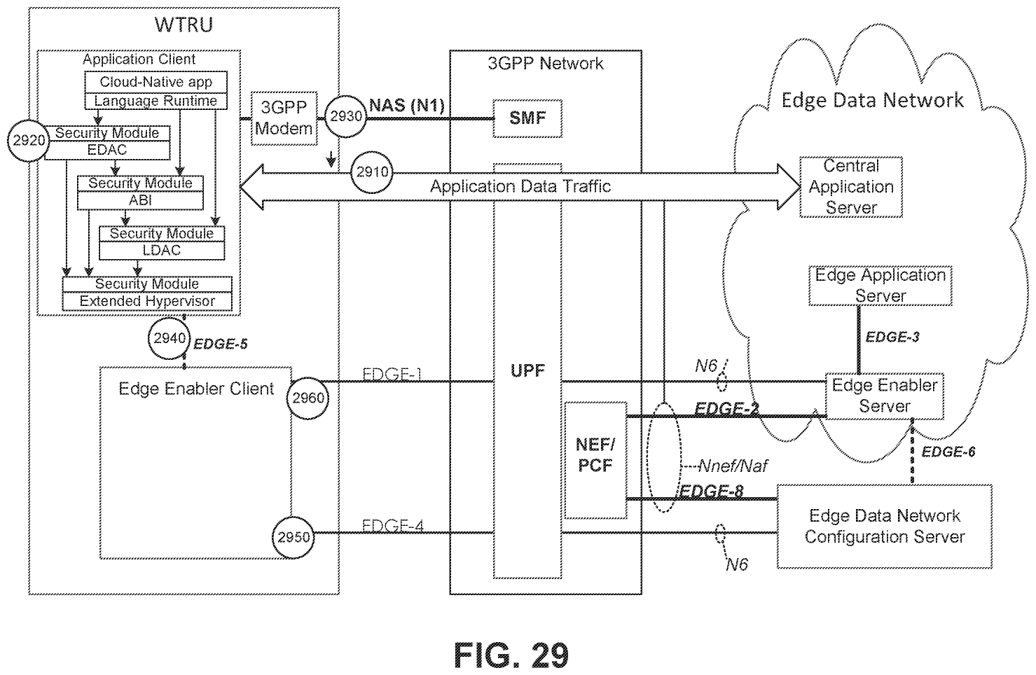

An application specific ECS may be selected. The selection of one or more ECS's that are tailored to provision edge configuration hosting information may enable access to HW resources. FIG. 29 shows example operations associated with the discovery of HW resources, which may be located in one or more edge hosting environments and/or be suitable for one or more applications. The discovery of the HW resources may be enabled, for example, using the techniques described herein (e.g., with respect to discovering remote HW resources and/or obtaining access to those resources).

As shown in FIG. 29, a WTRU may be registered to a network (e.g., 3GPP network) and establish a PDU session, for example, to enable communication (e.g., application data traffic) between one or more application clients (e.g., on the WTRU) and a central server or distributed servers. At 2910, an application client may contact an application server and/or provide information (e.g., configuration information) such as geographical coordinates, PLMN ID, tracking area code and relevant S-NSSAI(s), and/or specific application requirements (e.g., relating to gaming) to the server. The configuration information may be associated with, for example, one or more of the following: a reference to an access token and an associated broker object; a configuration ID; handles to access a time stamp counter; an EFLAGS register; a translation look aside buffer; an access to calls (e.g., via handles) for fault and abort operations; etc. The application server may use this information to generate a list of resource IDs that match (e.g., best match) the requirements of the application client. The application server may provide the application client with the list of resource IDs.

At 2920, the application client may process the information (e.g., inputs) provided by the application server (e.g., a central application server) and carry out one or more of the following actions. In a first action, the application client may select one or more resources, for example, based on a current context, an inferred user intent, and/or specific application context (e.g., number of players in a game), which may collectively form a user intent vector. In a second action, the application client may construct an intent vector and provide it to an ECS (e.g., indicated by 2940 in FIG. 29), for example, as part of an application client profile.

The intent vector may be constructed based on the inferred user intent. The intent vector may be associated with hardware criteria. The hardware criteria may be associated with one or more of the following: access to a time stamp counter; a flags register, for example, such as an extended flags (EFLAGS) register (e.g., a register that may hold bits, for example, that may characterize instruction results (e.g., zero, negative, etc.) and which may be tested by conditional branch instructions); a translation look aside buffer; and/or access to calls (e.g., via handles), for example, for fault and abort operations. The hardware criteria may be a subset of user intent (e.g., which may be generated at the WTRU).

User intent may be associated with hardware criteria (e.g., as described herein). For example, user intent may be associated the location of an associated data's URL; a type of data (e.g., Boolean, floating point, integer); artificial intelligence (AI) and/or machine learning (ML) techniques that may be used to infer a desired action(s) of a user (e.g., based on the user habits, previous actions, and/or context).

User intent may be associated with a context (e.g., application context, user context, system-based context, game-based context, etc.). System-based context may be associated with, for example, one or more of the following: a number of hops between a WTRU and a server (e.g., edge server); wireless conditions (e.g., signal strength at the WTRU), and/or processor and memory utilization on the WTRU.

Game-based context may be associated with, for example, one or more of the following: a number of players; images to display; color of background/scenery; a number of objects (e.g., magic items) available to a player; a direction that the player is facing; a time of the day; a location; an audience rating (e.g., over 18, PR); etc.

At 2930, the application client may trigger a PDU session (e.g., a new PDU session) and provide the resource ID (e.g., a new resource ID) generated in 2920. An SMF may use this ID to select an endpoint address of an ECS associated to the resource ID and provide the address to the WTRU, for example, in a suitable format such as within protocol configuration options (PCO), in a PDU session establishment accept message, etc.

At 2940, the application client may (e.g., using the various IDs generated/obtained) request provisioning information from an edge enabler client (EEC). The application client may pass the list of ECS addresses that satisfy the HW requirements to the EEC (e.g., as part of the request). The application client may include an intent vector in the request, for example, if the application client has constructed the intent vector as described herein.

At 2950, the EEC may request provisioning information (e.g., from the ECS) that may be associated with accessing specific HW resources. In examples (e.g., if the application client has constructed an intent vector as described herein), the EEC may include the intent vector in the application client profile that the EEC may send to the ECS. The ECS may select a relevant configuration according to the information provided by the EES (e.g., which may include the user intent vector).

At 2960, the EEC may use the configuration information provided by the ECS to select an EES. Table 1 below shows example contents of a user intent vector that may be included in an application client profile, as described herein (e.g., M indicates that an information element may be mandatory and O indicates that the information element may be optional).

TABLE 1
Example User Intent Vector in an Application Client Profile

| Information | Sta- | |
|---|---|---|
| element | tus | Description |
| Application | M | Identity of the Application Client. |
| Client ID | | |
| Application | O | The category or type of the Application Client (e.g. |
| Client Type | | V2X). This may be an implementation specific |
| | | value. |
| Preferred | O | When used in a service provisioning request, this |
| ECSP list | | IE may indicate to the ECS which ECSPs are |
| | | preferred for the AC. The ECS may use this |
| | | information in the selection of EESs. |
| Application | O | The expected operation schedule of the Application |
| Client | | Client (e.g. time windows). |
| Schedule | | |
| Expected | O | The expected location(s) (e.g. route) of the hosting |
| Application | | WTRU during the Application Client's operation |
| Client | | schedule. This geographic information may |
| Geographical | | express a geographic point, polygon, route, |
| Service Area | | signalling map, or waypoint set. |
| Service | O | Indicates if service continuity support may be |
| Continuity | | required or not for the application. |
| Support | | |
| List of EASs | O | List of EAS(s) that may serve the Application |
| | | Client along with the service key performance |
| | | indicators (KPIs) for the Application Client |
| >EAS ID | M | Identifier of the EAS |
| >Application | O | KPIs associated with receiving services from the |
| Client | | EAS |
| Service KPIs | | |
| User Intent | O | Indicates application user analytics, e.g., gamer |
| Vector | | profile, user preferences, user statistics, etc. |

Security measures may be considered when accessing edge hosting environment resources. An EEC may be authorized and/or authenticated (e.g., before an ECS may be accessed) to request provisioning of edge configuration information from the ECS. Results of WTRU primary authentication (e.g., implemented via a WTRU 3GPP modem) may be utilized for the authorization and/or authentication.

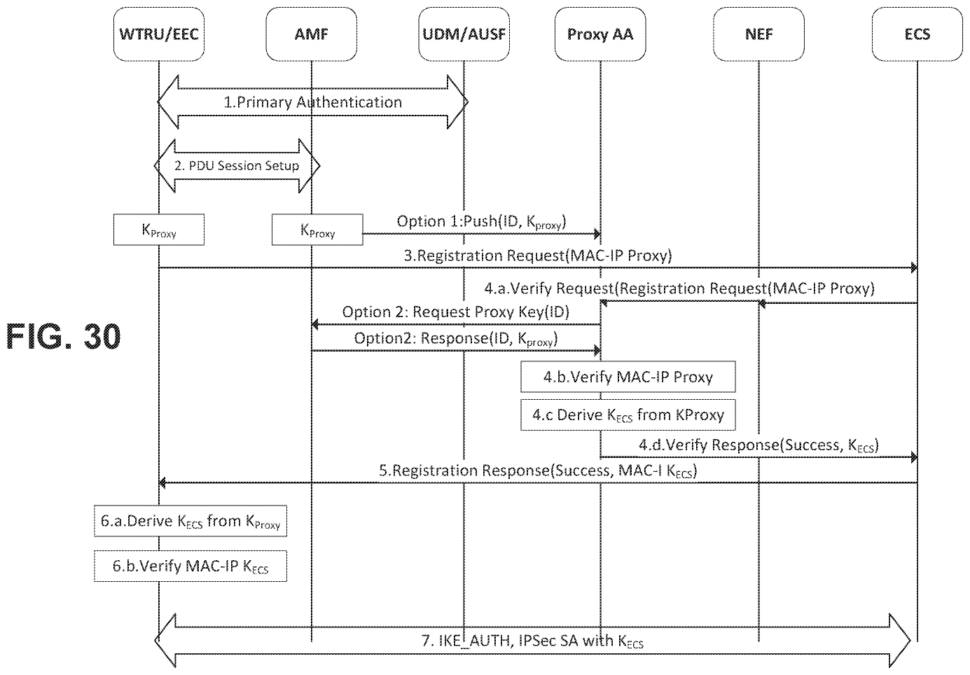

FIG. 30 illustrates example authorization and authentication techniques. A resource ID as described herein may be used to derive the Kproxy (e.g., at an EEC), for example, to guarantee access to specific HW resources, based on application needs.

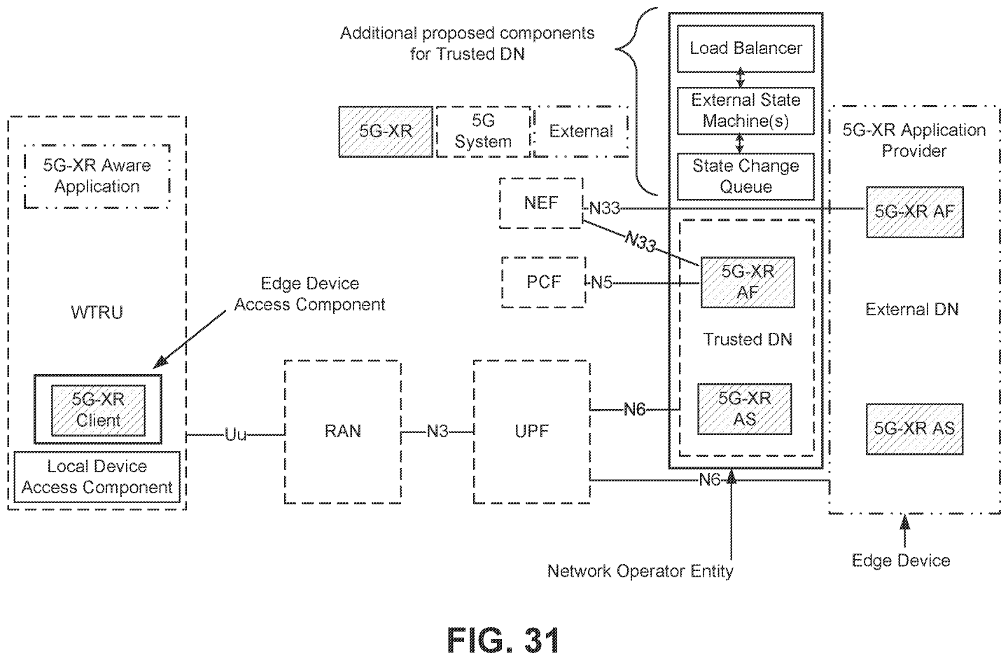

Combined access to remote and local HW resources may be supported. GPU hardware may be used to process graphical data, for example, in applications such as extended reality (XR). FIG. 31 shows an example architecture that supports an XR application running on a network (e.g., 5G network). As shown in FIG. 31, a client (e.g., 5G-XR client) may play the role of an EDAC as described herein. The EDAC's performance may be accelerated. The EDAC's performance may be accelerated by allowing it to access GPU hardware and/or TCP implementations (e.g., faster TCP implementations) in the HW directly, for example, through additional components such as the local device access component (LDAC) on the UE (e.g., a WTRU) as shown in FIG. 31. A trusted data network (DN) may be extended to include a load balancer, an external state machine, and/or a state change queue. This extended trusted DN may be an example of the network operator entity (NOE) as described herein.

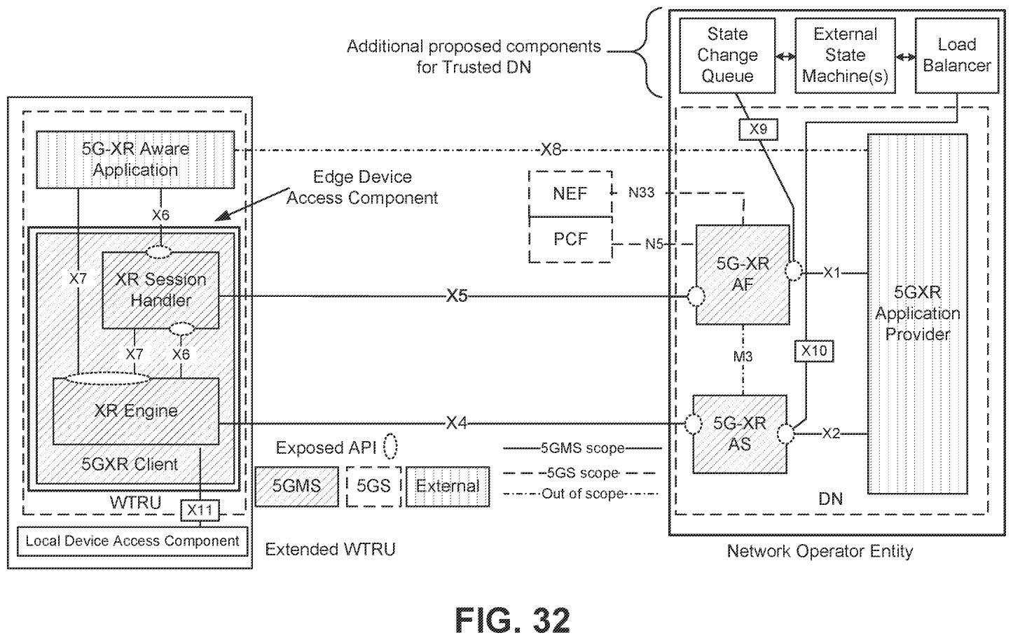

FIG. 32 shows example interfaces (e.g., 5G-XR interfaces) and/or architecture that may allow an EDAC to access LDAC features. As shown, an XR Engine component of a 5G-XR client may be connected to an LDAC, for example, via an interface X11 (e.g., that may be an example of the interface offered by a hardware provisioning module (HPM) discussed herein). A trusted DN may be extended by an interface X9 that may connect a 5GXR AF to a state change queue module. An interface X10 may connect a 5G-XR AS to a load balancer module.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-20. (canceled)

21. A wireless transmit/receive unit (WTRU), the WTRU comprising:
a processor, the processor configured to:
receive a first message from a network node, wherein the first message indicates a list of hardware resource identifiers for one or more hardware resources, wherein a hardware resource of of the one or more hardware resources is associated with a respective hardware criterion for an application executing on the WTRU;
select the hardware resource based on the hardware criterion;
send a second message to the network node, wherein the second message indicates a request to establish a data session, and wherein the second message indicates a resource identifier for the selected hardware resource; and
receive a third message from the network node, wherein the third message indicates configuration information to access the selected hardware resource, wherein the configuration information is associated with a second network node that provides the hardware resource, and wherein the third message is received in response to the request to establish the data session.

22. The WTRU of claim 21, wherein the processor is further configured to send a fourth message using the data session, wherein the fourth message comprises data for the selected hardware resource.

23. The WTRU of claim 21, wherein the processor is further configured to receive a fifth message, wherein the fifth message indicates a third network node associated with the resource.

24. The WTRU of claim 23, wherein the third network node is an edge configuration server.

25. The WTRU of claim 21, wherein the configuration information indicates at least one of a configuration identification, a reference to an access token, a reference to a broker object, a handle associated with a time stamp counter, a flags register, a reference to a buffer, an access to a call, an access to a fault code, or an access to an operation.

26. The WTRU of claim 21, wherein the request indicates a user intent, and wherein the user intent is mapped to the selected hardware resource.

27. The WTRU of claim 21, wherein the processor is further configured to send initialization information to the network, wherein the initialization information indicates at least one of a location of the WTRU, a WTRU identification, or the hardware criterion.

28. The WTRU of claim 21, wherein the location of the WTRU is associated with at least one of a geographical coordinate, a network location, a distance from the WTRU, a distance within a network, or a number of hops.

29. The WTRU of claim 21, wherein the hardware criterion is at least one of a quality of service associated with the application, a quality of service associated with the data session, a performance requirement for the hardware resource, a memory requirement for the hardware resource, or a context associated with the application.

30. The WTRU of claim 21, wherein the hardware resource identifier is further selected based on a context associated with the application, and wherein the context is at least one of a number of hops between the WTRU and the first network node, a network condition, a processor utilization associated with the WTRU, a memory utilization associated with the WTRU, a number of players in a game, an image to be displayed, a color of a display background, a scenery, a number of objects available to a player, a viewing direction, a time of day, a location, or an audience rating.

31. A method comprising:
receiving a first message from a network node, wherein the first message indicates a list of hardware resource identifiers for one or more hardware resources, wherein a hardware resource of the one or more hardware resources is associated with a respective hardware criterion for an application executing on the WTRU;
selecting the hardware resource based on the hardware criterion;
sending a second message to the network node, wherein the second message indicates a request to establish a data session, and wherein the second message indicates a resource identifier for the selected hardware resource; and
receiving a third message from the network node, wherein the third message indicates configuration information to access the selected hardware resource, wherein the configuration information is associated with a second network node that provides the hardware resource, and wherein the third message is received in response to the request to establish the data session.

32. The method of claim 31, further comprising
sending send a fourth message using the data session, wherein the fourth message comprises data for the selected hardware resource.

33. The method of claim 31, further comprising:
receiving a fifth message, wherein the fifth message indicates a third network node associated with the resource.

34. The method of claim 33, wherein the third network node is an edge configuration server.

35. The method of claim 31, wherein the configuration information indicates at least one of a configuration identification, a reference to an access token, a reference to a broker object, a handle associated with a time stamp counter, a flags register, a reference to a buffer, an access to a call, an access to a fault code, or an access to an operation.

36. The method of claim 31, wherein the request indicates a user intent, and wherein the user intent is mapped to the selected hardware resource.

37. The method of claim 31, further comprising:
sending initialization information to the network, wherein the initialization information indicates at least one of a location of the WTRU, a WTRU identification, or the hardware criterion.

38. The method of claim 31, wherein the location of the WTRU is associated with at least one of a geographical coordinate, a network location, a distance from the WTRU, a distance within a network, or a number of hops.

39. The method of claim 31, wherein the hardware criterion is at least one of a quality of service associated with the application, a quality of service associated with the data session, a performance requirement for the hardware resource, a memory requirement for the hardware resource, or a context associated with the application.

40. The method of claim 31, wherein the hardware resource identifier is further selected based on a context associated with the application, and wherein the context is at least one of a number of hops between the WTRU and the first network node, a network condition, a processor utilization associated with the WTRU, a memory utilization associated with the WTRU, a number of players in a game, an image to be displayed, a color of a display background, a scenery, a number of objects available to a player, a viewing direction, a time of day, a location, or an audience rating.
